(19) United States
(12) Patent Application Publication
(10) Pub. No.: US 2019/0295072 A1
(43) Pub. Date: Sep. 26, 2019

(54) AUTHORIZATION METHOD AND SYSTEM FOR ON-BEHALF TRANSACTIONS

(71) Applicant: MASTERCARD INTERNATIONAL INCORPORATED, PURCHASE, NY (US)

(72) Inventors: Navneet Jain, Pune (IN); Ganesh Shinde, Pune (IN); Ravi Pareek, Pune (IN)

(21) Appl. No.: 16/357,269

(22) Filed: Mar. 18, 2019

(30) Foreign Application Priority Data
Mar. 23, 2018 (SG) 10201802415R

(51) Int. Cl. G06Q 20/38; G06Q 20/40

(52) U.S. Cl. CPC G06Q 20/385; G06Q 20/40

(57) ABSTRACT

A transaction authorization method includes generation of a unique identification code for registering a user as an on-behalf payee for an account based on a registration request raised by an account holder of the account. The user is authorized to perform on-behalf transactions from the account by using the unique identification code. The account holder is notified, when the user performs an on-behalf transaction from the account. The on-behalf transaction is authorized, when the account holder approves the on-behalf transaction and is declined, when the account holder rejects the on-behalf transaction.

### BACKGROUND OF THE INVENTION

This invention claims the benefit of priority to Singapore Patent Application No. 10201802415R, filed Mar. 23, 2018, entitled “Authorization Method and System for On-Behalf Transactions”, the entirety of which is incorporated herein.

### FIELD OF THE INVENTION

The present invention relates to method and system for conducting electronic transactions, and more particularly to method and system for authorization to conduct on-behalf electronic transactions.

### BACKGROUND

Technological advancements have led to an emergence and evolution of several payment platforms that enable users to perform financial transactions. Examples of such payment platforms include automated teller machines (ATMs), point-of-sale (POS) devices, and online payment gateways. Typically, these payment platforms require at least one of a bank account, a transaction card, or an e-wallet for performing the financial transactions. In one example, a user, who has to withdraw cash from her account at an ATM, requires a transaction card, such as a debit card or a credit card, which is linked to the account. In another example, a user, who has purchased a product from a merchant store, requires at least one of a cash equivalent to the price of the product, a transaction card linked to a bank account, or a smartphone having an e-wallet installed therein to pay for the product.

Every account and e-wallet has a primary account holder, who is authorized to perform financial transactions from the corresponding account and the e-wallet. In a scenario, when a family member of the primary account holder has to perform a financial transaction from the account, the primary account holder has to give her transaction card or the smartphone hosting the e-wallet to the family member for performing the financial transaction. However, under certain circumstances it becomes difficult for the primary account holder to provide her transaction card or the smartphone to the family member, which may cause inconvenience to both the family member and the primary account holder. To avoid such situations, the primary account holder usually applies for add-on cards linked to the account for her family members or share a password linked to the e-wallet with the family members.

Although the add-on cards and shared password reduce the inconvenience, the primary account holder loses control over the financial transactions performed from her account by the family members. In addition, it is mandatory to carry a corresponding add-on card or remember the shared password, if a family member of the primary account holder wishes to perform a financial transaction from the account. Thus, in a scenario when the family member has not carried the corresponding add-on card along or has forgotten the shared password, there is no way that she can perform a financial transaction from the account. Moreover, the possibility of the password getting compromised increases when more people know the shared password, thereby posing a threat of fraudulent financial transactions from the account.

In light of the foregoing, there exists a need for a solution that extends beyond the requirement of having one of a bank account, a transaction card, or an e-wallet for performing financial transactions and enables a user, who is not the account holder of an account, to perform the financial transactions from the account without using the transaction card or a smartphone linked to the account at the consent of the account holder.

### SUMMARY

In an embodiment of the present invention, a transaction authorization method is provided. A unique identification code is generated by a server (such as a payment network server, an issuer server, or a third-party server maintaining an account of an account holder) to register a first user as an on-behalf payee for the account of the account holder. An authorization request is received by the server for a transaction performed by the first user at a first device by using the unique identification code. The account holder is notified by way of a notification that the transaction is performed by the first user. The notification includes details of the first user and a transaction amount of the transaction. The transaction is authorized by the server, when the account holder approves the transaction based on the notification. An approval message is transmitted to the first device by the server to process the transaction for deducting the transaction amount from the account, when the transaction is authorized.

In another embodiment of the present invention, a transaction authorization system is provided. The system includes an issuer server that includes a processor. The processor generates a unique identification code to register a first user as an on-behalf payee for an account of an account holder. The processor receives an authorization request for a transaction performed by the first user at a first device by using the unique identification code. The processor notifies the account holder by way of a notification that the transaction is performed by the first user. The notification includes details of the first user and a transaction amount of the transaction. The processor authorizes the transaction, when the account holder approves the transaction based on the notification. The processor transmits an approval message to the first device for processing the transaction, when the transaction is authorized.

In yet another embodiment of the present invention, a transaction authorization method is provided. A unique identification code that is received from an issuer server is mapped to an account of an account holder by a payment network server. A first user is registered as an on-behalf payee by the issuer server to perform one or more transactions from the account by using the unique identification code. An authorization request, for a transaction performed by the first user at a first device by using the unique identification code, is received by the payment network server. The account holder is notified by way of a notification that the transaction is performed by the first user. The notification includes details of the first user and a transaction amount of the transaction. The transaction is authorized by the payment network server, when the account holder approves the transaction based on the notification. An approval message is transmitted, by the payment network server to the first device, to process the transaction for deducting the transaction amount from the account, when the transaction is authorized.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements:

FIG. 1 is a block diagram that illustrates a communication environment for authorizing on-behalf transactions, in accordance with an embodiment of the present invention;

FIG. 2 is a block diagram that illustrates an issuer server of the communication environment of FIG. 1, in accordance with an embodiment of the present invention;

FIG. 3 is a block diagram that illustrates a payment network server of the communication environment of FIG. 1, in accordance with another embodiment of the present invention;

FIG. 4 is a block diagram that illustrates a merchant server of the communication environment of FIG. 1, in accordance with another embodiment of the present invention;

FIG. 5A is a process flow diagram that illustrates an exemplary scenario for registering a user as an on-behalf payee for an account, in accordance with an embodiment of the present invention;

FIG. 5B is a table that illustrates an updated account profile of an account for which a user is registered as an on-behalf payee, in accordance with an embodiment of the present invention;

FIGS. 6A-6C are process flow diagrams that illustrate exemplary scenarios for authorizing on-behalf transactions, in accordance with an embodiment of the present invention;

FIGS. 7A-7C are process flow diagrams that illustrate exemplary scenarios for authorizing on-behalf transactions, in accordance with another embodiment of the present invention;

FIG. 8 is a process flow diagram that illustrates an exemplary scenario for registering a user as an on-behalf payee for an e-wallet, in accordance with another embodiment of the present invention;

FIGS. 9A-9C are process flow diagrams that illustrate exemplary scenarios for authorizing on-behalf transactions that are performed from e-wallets, in accordance with another embodiment of the present invention;

FIG. 10 represents a flow chart that illustrates a method for registering on-behalf payees for an account of an account holder, in accordance with an embodiment of the present invention;

FIGS. 11A and 11B collectively represent a flow chart that illustrates a method for authorizing an on-behalf transaction, in accordance with an embodiment of the present invention;

FIGS. 12A and 12B collectively represent a flow chart that illustrates a method for authorizing an on-behalf transaction, in accordance with another embodiment of the present invention;

FIG. 13 represents a flow chart that illustrates a method for registering an on-behalf payee for an e-wallet, in accordance with another embodiment of the present invention;

FIGS. 14A and 14B collectively represent a flow chart that illustrates a method for authorizing an on-behalf transaction that is performed from an e-wallet, in accordance with another embodiment of the present invention;

FIG. 15 represents a high-level flow chart that illustrates a method for authorizing an on-behalf transaction, in accordance with an embodiment of the present invention; and

FIG. 16 is a block diagram that illustrates system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

Various embodiments of the present invention provide a method and a system for authorizing on-behalf transactions. An account holder of an account, such as a bank account or an e-wallet, raises a registration request to register a user as an on-behalf payee for the account. Based on the registration request of the account holder, a server (such as an issuer server, a payment network server, a merchant server, or a third-party server) generates a unique identification code (UIC) for registering the user as the on-behalf payee for the account. The server communicates the UIC to the user and maps the UIC to the account for storing. Once registered as the on-behalf payee, the user is authorized to perform the on-behalf transactions from the account without requiring a transaction card or a mobile application linked to the account. When the user performs an on-behalf transaction at a first device (such as a communication device or a terminal device) by using the UIC, the server receives an authorization request for authorizing the on-behalf transaction. The server validates the UIC and notifies the account holder that the user has performed the on-behalf transaction from the account. The account holder may approve or reject the on-behalf transaction. When the account holder approves the on-behalf transaction, the server authorizes the on-behalf transaction and transmits an approval message to the first device for processing the on-behalf transaction. Conversely, when the account holder rejects the on-behalf transaction, the server declines the on-behalf transaction and transmits a rejection message to the first device for declining the on-behalf transaction.

Thus, the method and the system of the present invention allow an account holder to register on-behalf payees for her account or e-wallet. The on-behalf payees are authorized to perform the on-behalf transactions from the account or the e-wallet of the account holder based on consent of the account holder. The on-behalf payees do not require any transaction cards, mobile applications, or smartphones linked to the account or the e-wallet for performing the on-behalf transactions. Thus, the account holder has full control over any transaction that is performed from her account and e-wallet. In addition, the method and the system of the present invention enable the account holder to add multiple on-behalf payees for a single account or e-wallet, such that each on-behalf payee has a different UIC. Since the password of the account or the e-wallet is only known to the account holder, the threat of fraudulent transactions from the account or the e-wallet is minimized.

### Terms Description (in Addition to Plain and Dictionary Meaning)

On-behalf transaction is a type of transaction that is performed by a user from an account, when the user is not the account holder of the account. The user is registered as an on-behalf payee for the account based on a registration request from the account holder. The user uses a unique identification code (UIC) for performing the on-behalf transaction from the account and does not require any transaction card or mobile application linked to the account for performing the on-behalf transaction. The UIC is assigned to the user by an entity, such as an issuer bank, a merchant, or a third-party service provider, which maintains the account of the account holder. Examples of the account include a bank account, an e-wallet, and the like.

First device is a device using which an on-behalf payee performs an on-behalf transaction from an account. In one example, the first device is a communication device, such as a smartphone, a mobile phone, a laptop, a tablet, or a phablet, of the on-behalf payee. In another example, the first device is an automated teller machine (ATM), a point-of-sale (POS) device, a point-of-interaction (POI) device, a point-of-purchase (POP) device, and/or a near field communication (NFC) POS device, or the like.

Authorization is a method of validating a transaction means used for performing the transaction. In one example, when a transaction is performed by using a transaction card, authorization includes verification that whether the transaction card is eligible for performing the transaction or not. For example, when an individual uses a stolen debit card to perform a transaction, a banking authority responsible for authorizing transactions determines that the transaction is not authorized. In another example, when a transaction is performed by using a UIC, authorization includes verification that whether the UIC is valid or invalid.

Authentication is a process of verifying the identity of a user. For example, authenticating a user who initiates a transaction from an account corresponds to an act of ensuring that the user is authorized to perform transactions from the account. Several authentication methods that are deployed on existing payment platforms use unique passkeys, such as authentication passwords, personal identification numbers (PINs), one-time-passwords (OTPs), and the like. In such implementations, a unique passkey is provided to a user for performing transactions from an account. Therefore, when the user initiates a transaction from the account, the unique passkey is required to complete the transaction. Various input mechanisms are available to users for providing the unique passkey. For example, for a transaction carried out using a web-browser, the user may enter a password or an OTP by using virtual keys displayed on the screen or by pressing keyboard keys. Similarly, the user may enter a PIN by pressing keys of an ATM, a POS device, a POI device, a POP device, and/or a NFC POS device.

Transaction cards include payment devices, such as debit cards, credit cards, prepaid cards, gift cards, promotional cards, contactless cards, and/or other devices that may hold identification information of an account. The transaction cards can be used to perform transactions, such as deposits and withdrawals, credit transfers, purchase payments, and the like. The transaction cards may be radio frequency identification (RFID) or NFC enabled for performing contactless payments.

An ATM is a computing device affiliated with a financial institution, such as a bank. The ATM enables a user to perform various electronic transactions, such as cash withdrawals, and the like.

A POS device, a POI device, a POP device, and an NFC-POS device are computing devices installed within retail establishments, such as merchant stores, for facilitating electronic transactions.

Merchant is an entity that offers various products and/or services in exchange of payments. The merchant may establish a merchant account with a financial institution, such as a bank (hereinafter “acquirer bank”) to accept the payments from several users by use of one or more payment methods.

Issuer or issuer bank is a financial institution, such as a bank, where accounts of several users are established and maintained. The issuer bank ensures payment for authorized transactions in accordance with various payment network regulations and local legislation.

Payment network is an institution that acts as an intermediate entity between acquirer banks and issuer banks to authorize and fund transactions. Examples of payment networks include MasterCard®, American Express®, VISA®, Discover®, Diners Club®, and the like. The payment network settles the transactions between various acquirer banks and issuer banks, when transaction cards are used for initiating transactions. The payment network authorizes transactions performed by use of transaction cards. For example, if a user uses a stolen debit card for performing a transaction, the payment network may not authorize the transaction.

A server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of a payment network server, an issuer server, a digital wallet server, an acquirer server, or a merchant server.

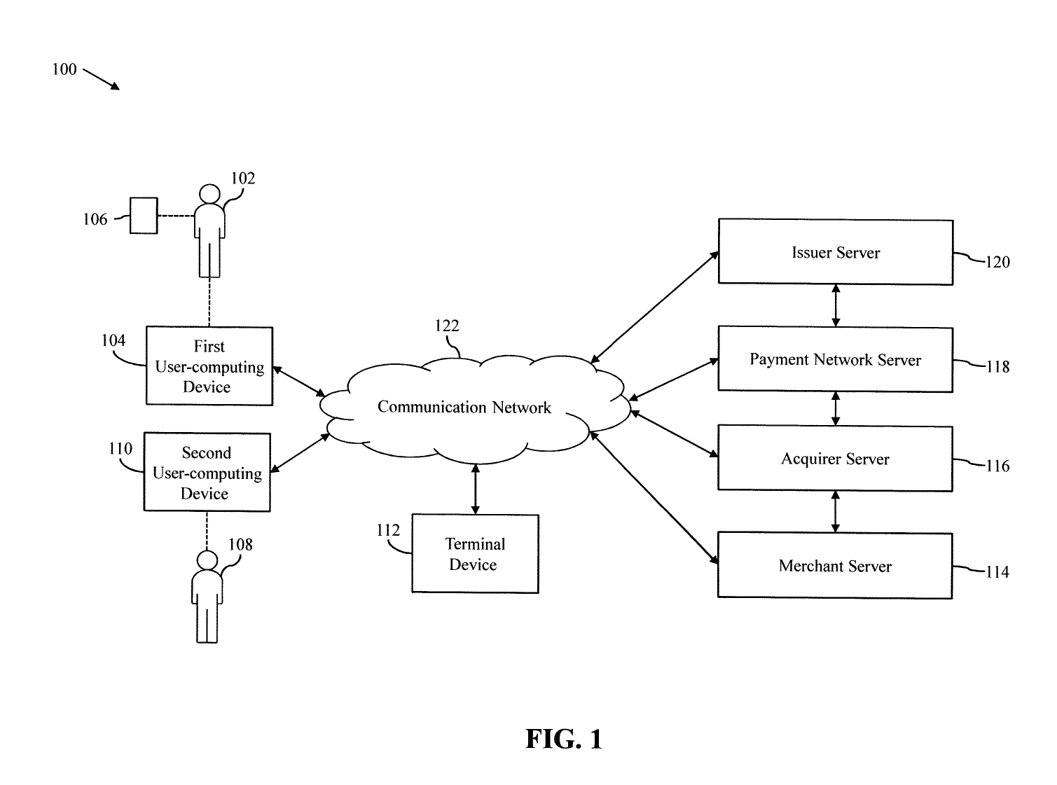

Referring now to FIG. 1, a block diagram that illustrates a communication environment 100 for authorizing on-behalf transactions, in accordance with an embodiment of the present invention, is shown. The communication environment 100 includes a first user 102 in possession of a first user-computing device 104 and a transaction card 106, and a second user 108 in possession of a second user-computing device 110. The communication environment 100 further includes a terminal device 112, a merchant server 114, an acquirer server 116, a payment network server 118, and an issuer server 120. The first and second user-computing devices 104 and 110 communicate with the merchant server 114, the acquirer server 116, the payment network server 118, and the issuer server 120 by way of a communication network 122.

The first user 102 is an individual, who is an account holder of a first account and an e-wallet. The e-wallet is a digital wallet maintained by one of a third-party service provider or a merchant (not shown). The first account is a bank account maintained by a financial institution, such as an issuer bank. The issuer bank may have issued the transaction card 106 to the first user 102 for performing transactions from the first account. The transaction card 106 is linked to the first account and stores identification information of the first account (hereinafter referred to as “account identification information of the first account”) in form of an electronic chip or a machine readable magnetic strip. The account identification information may include an account number, a name of an account holder (i.e., the first user 102), or the like. The transaction card 106 further has a unique card number, an expiry date, a card security code, and a card type associated to it. In one embodiment, the transaction card 106 is a physical card. In another embodiment, the transaction card 106 is a virtual card or a payment token that is stored electronically in a memory (not shown) of the first user-computing device 104. Examples of the transaction card 106 include a credit card, a debit card, a membership card, a promotional card, a charge card, a prepaid card, a gift card, or the like.

In one embodiment, the first user 102 raises registration requests for registering one or more users as on-behalf payees for the first account and the e-wallet. In one scenario, the first user 102 raises the registration requests by accessing websites associated with the first account and the e-wallet. In another scenario, the first user 102 raises the registration requests by accessing mobile applications, installed on the first user-computing device 104, associated with the first account and the e-wallet. In another embodiment, the first user 102 submits a registration form for registering the users as the on-behalf payees for the first account and the e-wallet. Once registered as an on-behalf payee for the first account, a user who is not the account holder of the first account is authorized to perform transactions from the first account without actually requiring the transaction card 106 or the mobile application linked to the first account. Similarly, once registered as an on-behalf payee for the e-wallet, a user who is not the account holder of the e-wallet is authorized to perform transactions from the e-wallet without actually requiring the mobile application linked to the e-wallet. The transactions performed by such on-behalf payees from the first account or the e-wallet are on-behalf transactions.

The first user-computing device 104 is associated with registered contact information of the first user 102 that is linked to the first account and the e-wallet. In one example, the registered contact information includes a registered contact number of the first user 102. In another example, the registered contact information includes a registered e-mail ID of the first user 102. The first user 102 registers the contact number and the e-mail ID, at the time she sets up the first account and the e-wallet. The first user 102 uses the first user-computing device 104 to raise the registration requests for registering the on-behalf payees for the first account and the e-wallet.

The second user 108 is an individual, who is registered as an on-behalf payee for the first account and the e-wallet based on a registration request raised by the first user 102 (i.e., the account holder of the first account and the e-wallet). Thus, the second user 108 is authorized to perform transactions from the first account and the e-wallet without requiring the transaction card 106, the corresponding mobile applications, or the first user-computing device 104.

The second user-computing device 110 is a communication device of the second user 108 and is associated with contact information of the second user 108. The contact information may include a contact number and/or an e-mail ID of the second user 108. Thus, all the calls/messages/e-mails that are made/sent to the contact number or the e-mail ID of the second user 108 are accessed by way of the second user-computing device 110. In one embodiment, the second user-computing device 110 is used by the second user 108 for performing transactions (i.e., on-behalf transactions) from the first account and the e-wallet.

Examples of the first and second user-computing devices 104 and 110 include, but are not limited to, mobile phones, smartphones, laptops, tablets, phablets, or any other communication devices.

The terminal device 112 is an electronic device using which users, such as the first and second users 102 and 108, perform transactions. The terminal device 112 presents various transaction options, such as transaction card, cardless transaction, quick response (QR) code, on-behalf transaction options, and/or the like, to the first and second users 102 and 108 for performing the transactions. In one embodiment, when the transaction card option is chosen by the first user 102 for performing a transaction, the terminal device 112 reads the account identification information held by the transaction card 106 using which the first user 102 performs the transaction. In another embodiment, when the QR code option is chosen by the first user 102 for performing the transaction, the terminal device 112 reads a QR code stored in the memory of the first user-computing device 104 for initiating the transaction. In yet another embodiment, when the cardless transaction option is chosen by the first user 102 for performing the transaction, the terminal device 112 requires an OTP from the first user 102 for initiating the transaction. The OTP may be communicated to the first user 102 by way of the first user-computing device 104. In such scenarios, the terminal device 112 transmits a transaction request to one of the acquirer server 116, the payment network server 118, and the issuer server 120 for processing the transaction.

In yet another embodiment, when the on-behalf transaction option is chosen by the second user 108, the terminal device 112 does not require to read the account identification information or the QR code from the transaction card 106 or the second user-computing device 110, respectively, for initiating the transaction. In addition, the terminal device 112 does not require the OTP communicated to the first user 102 on the first user-computing device 104 for initiating the transaction. In such a scenario, the terminal device 112 transmits an authorization request to one of the payment network server 118 and the issuer server 120 for authorizing the transaction. In an embodiment of the invention, the terminal device 112 transmits the authorization request to the payment network server 118 or the issuer server 120 by using dual-tone multi-frequency signaling (DTMF) code or an application programming interface (API). The terminal device 112 then either transmits the transaction request to one of the acquirer server 116, the payment network server 118, and the issuer server 120 for processing the transaction or presents a message indicating a decline of the transaction to the second user 108, based on the authorization. Examples of the terminal device 112 include, but are not limited to, an ATM linked with a financial institution, such as a bank, a POS device, a POI device, or a POP device installed at a merchant store of a merchant.

The merchant server 114 is a computing server or a payment gateway server that is associated with the merchant. The merchant may establish a merchant account with a financial institution, such as the acquirer bank, to accept payments for products and/or services. In one embodiment, the merchant server 114 is communicatively linked to the terminal device 112 installed at the merchant store via the communication network 122. In such a scenario, the merchant server 114 processes the transactions initiated at the terminal device 112. In another embodiment, the merchant server 114 is communicatively linked to an online payment gateway used by the first and second users 102 and 108 for performing e-commerce transactions. In one embodiment, the merchant server 114 may maintain the e-wallet of the first user 102.

The acquirer server 116 is a computing server that is associated with the acquirer bank. The acquirer bank processes transaction requests received from one of the terminal device 112 and the merchant server 114 by using the acquirer server 116. The acquirer server 116 transmits the transaction requests to payment networks or issuer banks associated with accounts from which the corresponding transactions are initiated, via the communication network 122. The acquirer server 116 transmits a transaction request for determining whether corresponding account holder's available credit line or account balance covers a transaction amount of the transaction. The acquirer server 116 credits or debits the merchant account in the acquirer bank with the transaction amount, when the transaction is captured at the issuer bank.

The payment network server 118 is a computing server that is associated with a payment network of various transaction cards, such as the transaction card 106. The payment network has a unique payment-network identification number assigned to it. The payment network server 118 represents an intermediate entity between the acquirer server 116 and the issuer server 120 for authorizing and funding the transactions performed by using the transaction cards, such as the transaction card 106. Examples of various payment networks include MasterCard, American Express, VISA, Discover, Diners Club, or the like. When the on-behalf transaction option is chosen at the terminal device 112 for performing a transaction, the payment network server 118 receives the authorization request from one of the terminal device 112, the merchant server 114, and the acquirer server 116. In one embodiment, the payment network server 118 processes the authorization request and performs one or more operations for authorizing the transaction. In another embodiment, the payment network server 118 transmits the authorization request to the issuer server 120 for performing authorization. The payment network server 118 further receives the transaction requests from one of the terminal device 112, the merchant server 114, and the acquirer server 116 and routes the transaction requests to corresponding issuer servers, such as the issuer server 120, for processing.

The issuer server 120 is a computing server that is associated with the issuer bank. The issuer bank is a financial institution that manages accounts of multiple users. The issuer bank has a unique bank identification number (BIN) assigned to it. Account details of the accounts, such as the first account, established with the issuer bank are stored as account profiles in a memory of the issuer server 120 or on a cloud server associated with the issuer server 120. The account details may include an account balance, a credit line, details of an account holder, transaction history of the account holder, account identification information, or the like. The details of the account holder may include name, age, gender, physical attributes, registered contact number, alternate contact number, registered e-mail ID, or the like of the account holder.

The issuer server 120 registers various users as on-behalf payees for accounts based on registrations requests raised by the corresponding account holders. For example, based on the registration request from the first user 102, the issuer server 120 registers the second user 108 as the on-behalf payee for the first account. The issuer server 120 updates the account profiles of the accounts by storing details of the corresponding on-behalf payees. The details of an on-behalf payee include a contact number, an e-mail ID, a name, a unique identification code (UIC), or the like of the on-behalf payee. The UIC is a unique passcode that is generated by the issuer server 120 during registration of the on-behalf payee and is different for each on-behalf payee. The issuer server 120 also provides the details of the on-behalf payees to the payment network server 118 for storing.

In one embodiment, when the on-behalf transaction option is chosen at the terminal device 112 for performing an on-behalf transaction from the first account, the issuer server 120 receives the authorization request from one of the terminal device 112, the merchant server 114, the acquirer server 116, or the payment network server 118 using, for example, a DTMF code. Based on the authorization request, the issuer server 120 performs one or more operations for authorizing the transaction. The issuer server 120 further receives various transaction requests from one of the terminal device 112, the merchant server 114, the acquirer server 116, and the payment network server 118 for processing. The issuer server 120 processes the transactions for either capture or decline.

Methods for processing transactions via the issuer server 120 will be apparent to persons having skill in the art and may include processing a transaction via the traditional four-party system or the traditional three-party system.

Examples of the merchant server 114, the acquirer server 116, the payment network server 118, and the issuer server 120 include, but are not limited to, computers, laptops, mini-computers, mainframe computers, any non-transient and tangible machines that can execute a machine-readable code, cloud-based servers, distributed server networks, or a network of computer systems.

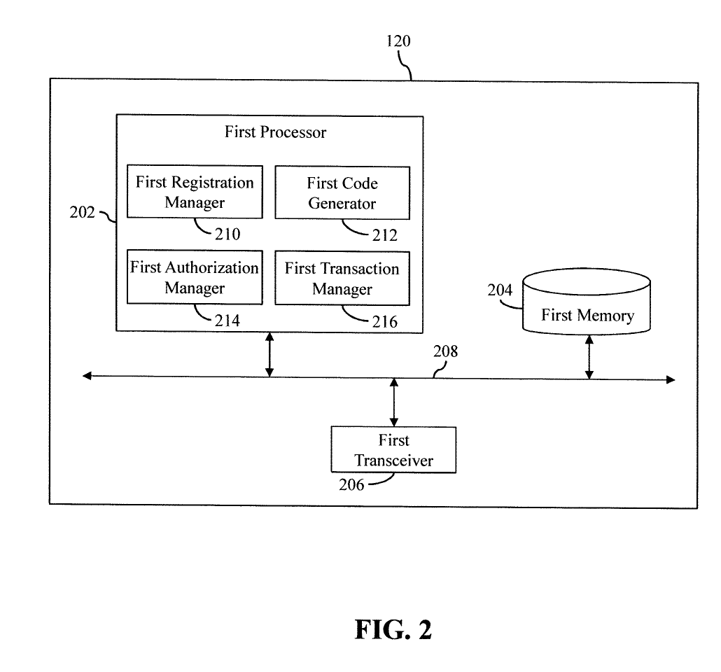

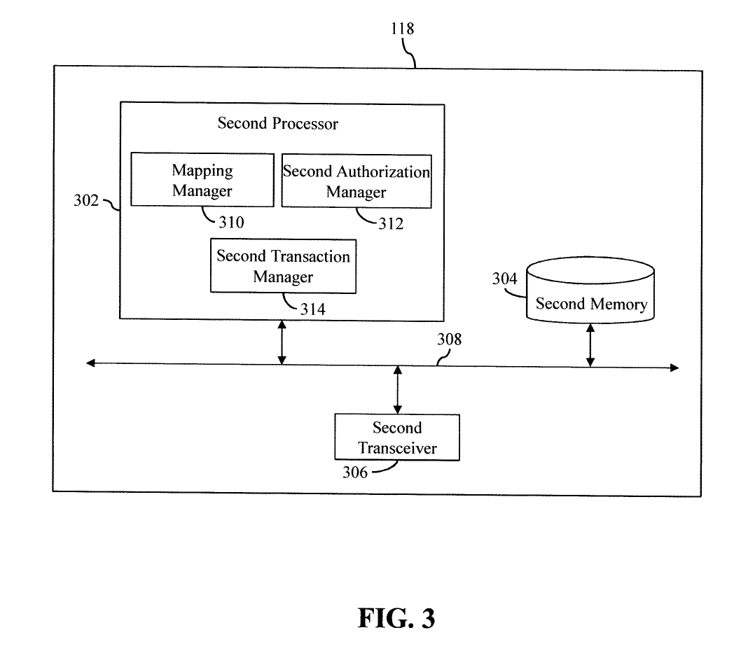

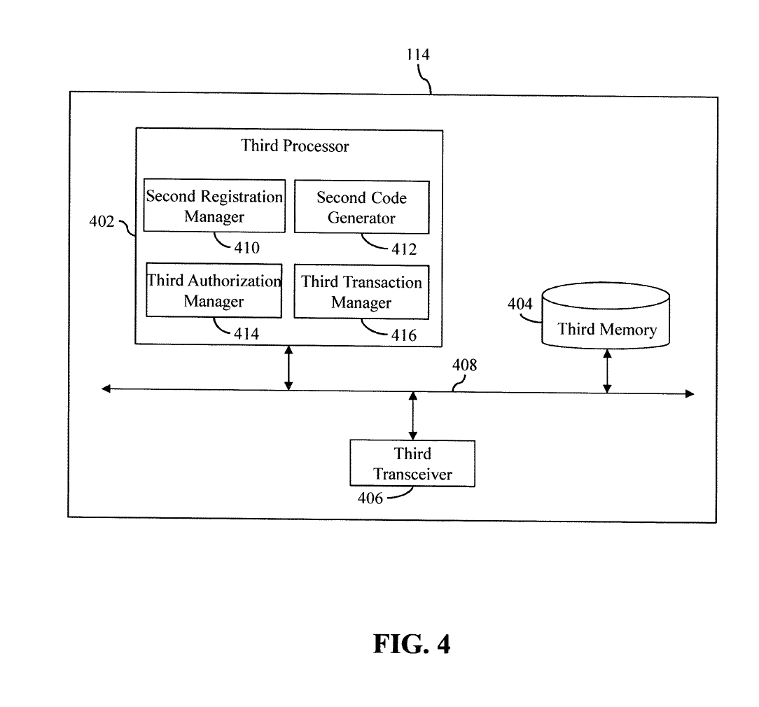

The communication network 122 is a medium through which content and messages are transmitted between various entities, such as the first and second user-computing devices 104 and 110, the terminal device 112, the merchant server 114, the acquirer server 116, the payment network server 118, and the issuer server 120. Examples of the communication network 122 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the communication environment 100 may connect to the communication network 122 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G) communication protocols, Long Term Evolution (LTE) communication protocols, or any combination thereof. Elements of the issuer server 120, the payment network server 118, and the merchant server 114 are explained in detail in conjunction with FIG. 2, FIG. 3, and FIG. 4, respectively.

Referring now to FIG. 2, a block diagram that illustrates the issuer server 120 of the communication environment 100 of FIG. 1, in accordance with an embodiment of the present invention, is shown. The issuer server 120 includes a first processor 202, a first memory 204, and a first transceiver 206 that communicate with each other via a first bus 208. The first processor 202 includes a first registration manager 210, a first code generator 212, a first authorization manager 214, and a first transaction manager 216. It will be apparent to a person skilled in the art that a third-party server (not shown) that maintains the e-wallet of the first user 102 may also be implemented by the block diagram of FIG. 2, without deviating from the scope of the invention.

The first processor 202 includes suitable logic, circuitry, and/or interfaces to execute operations for registering on-behalf payees for the accounts maintained at the issuer bank. The first processor 202 further executes the authorization of transactions, such as the on-behalf transactions. Based on the authorization, the first processor 202 processes the transactions for either capturing or declining the transactions. Examples of the first processor 202 include, but are not limited to, an application-specific integrated circuit (ASIC) processor, a reduced instruction set computing (RISC) processor, a complex instruction set computing (CISC) processor, a field-programmable gate array (FPGA), and the like. The first processor 202 executes the operations for authorizing and processing transactions by way of the first registration manager 210, the first code generator 212, the first authorization manager 214, and the first transaction manager 216.

The first memory 204 includes suitable logic, circuitry, and/or interfaces to store account profiles for the accounts that are maintained at the issuer bank. Examples of the first memory 204 include a random-access memory (RAM), a read-only memory (ROM), a removable storage drive, a hard disk drive (HDD), a flash memory, a solid-state memory, and the like. It will be apparent to a person skilled in the art that the scope of the invention is not limited to realizing the first memory 204 in the issuer server 120, as described herein. In other embodiments, the first memory 204 may be realized in form of a database server or a cloud storage working in conjunction with the issuer server 120, without departing from the scope of the invention.

The first transceiver 206 transmits and receives data over the communication network 122 using one or more communication network protocols. The first transceiver 206 transmits/receives various requests and messages to/from at least one of the first and second user-computing devices 104 and 110, the terminal device 112, the merchant server 114, the acquirer server 116, the payment network server 118, or other entities that are pursuant to one or more standards for the interchange of transaction messages, such as the ISO8583 standard. Examples of the first transceiver 206 include, but are not limited to, an antenna, a radio frequency transceiver, a wireless transceiver, a Bluetooth transceiver, an ethernet port, a universal serial bus (USB) port, or any other device configured to transmit and receive data.

The first registration manager 210 includes suitable logic, circuitry, and/or interfaces to execute operations for registering the on-behalf payees for the accounts maintained at the issuer bank based on the registration requests raised by the corresponding account holders. The first code generator 212 includes suitable logic, circuitry, and/or interfaces to execute operations for generating UICs for registering the on-behalf payees.

The first authorization manager 214 includes suitable logic, circuitry, and/or interfaces for authorizing the transactions that are performed by using the UICs (such as the on-behalf transactions). The first authorization manager 214 notifies an account holder, when a corresponding on-behalf payee performs a transaction from the corresponding account. For example, the first authorization manager 214 notifies the first user 102, when the second user 108 (i.e., the on-behalf payee of the first account of the first user 102) performs a transaction (such as an on-behalf transaction) from the first account. The first authorization manager 214 authorizes the transaction when the account holder (for example, the first user 102) approves the transaction and declines the transaction when the account holder rejects the transaction.

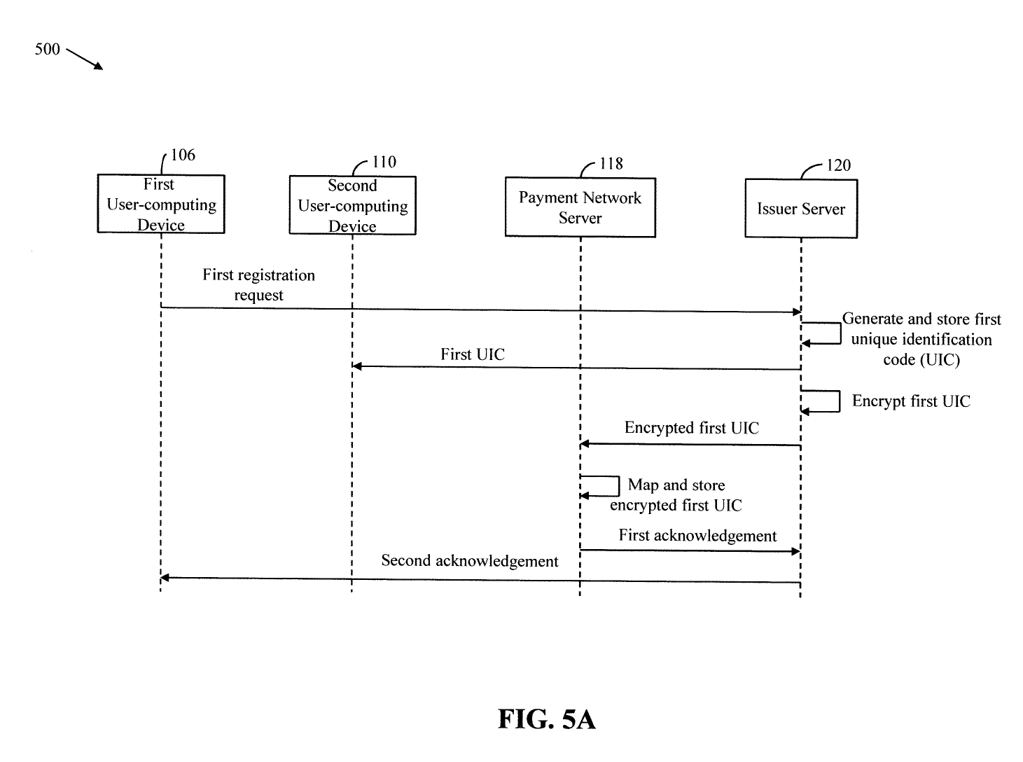

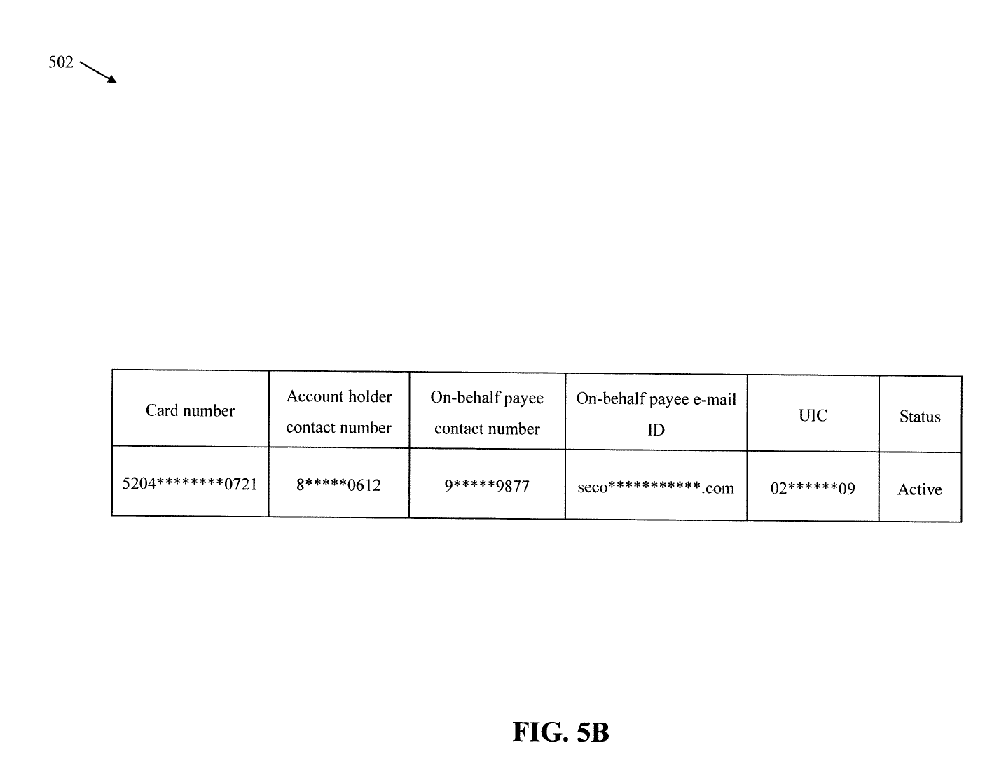

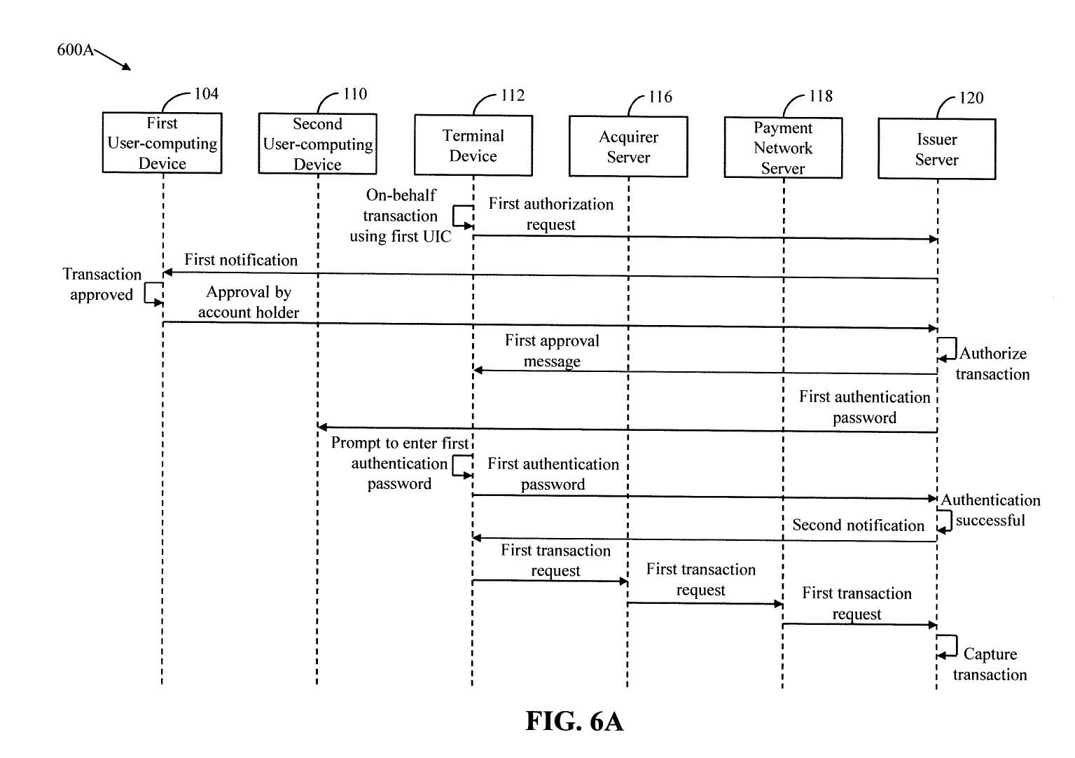

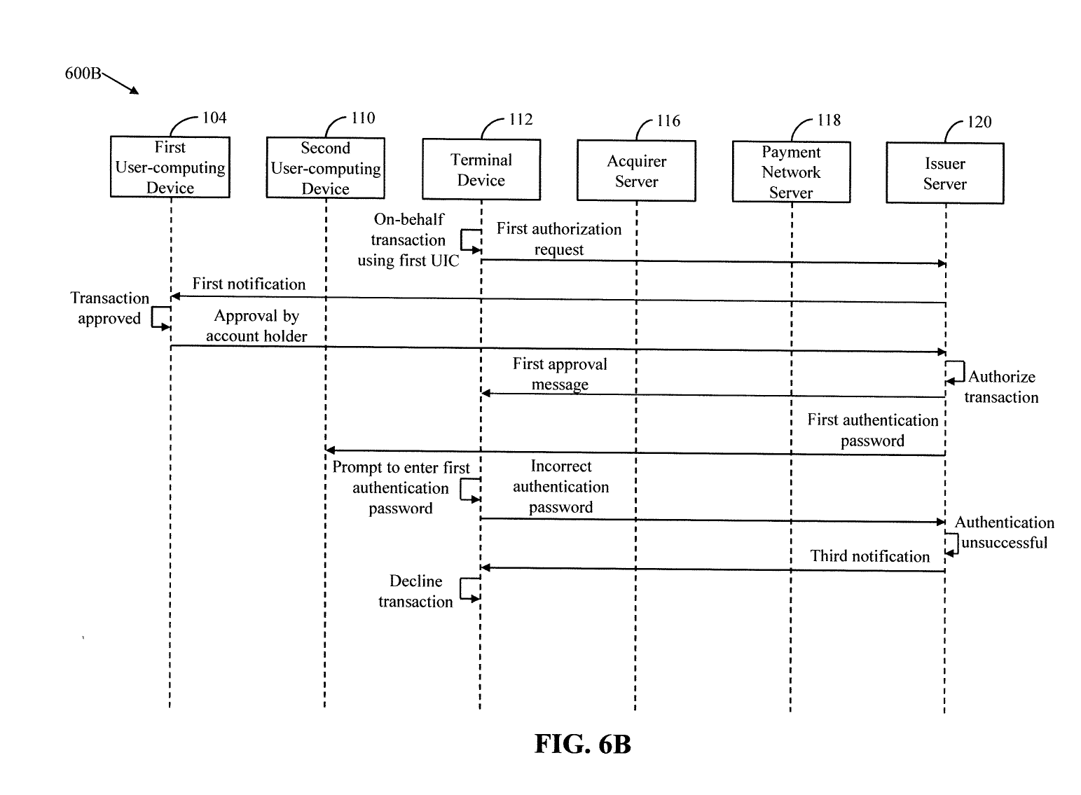

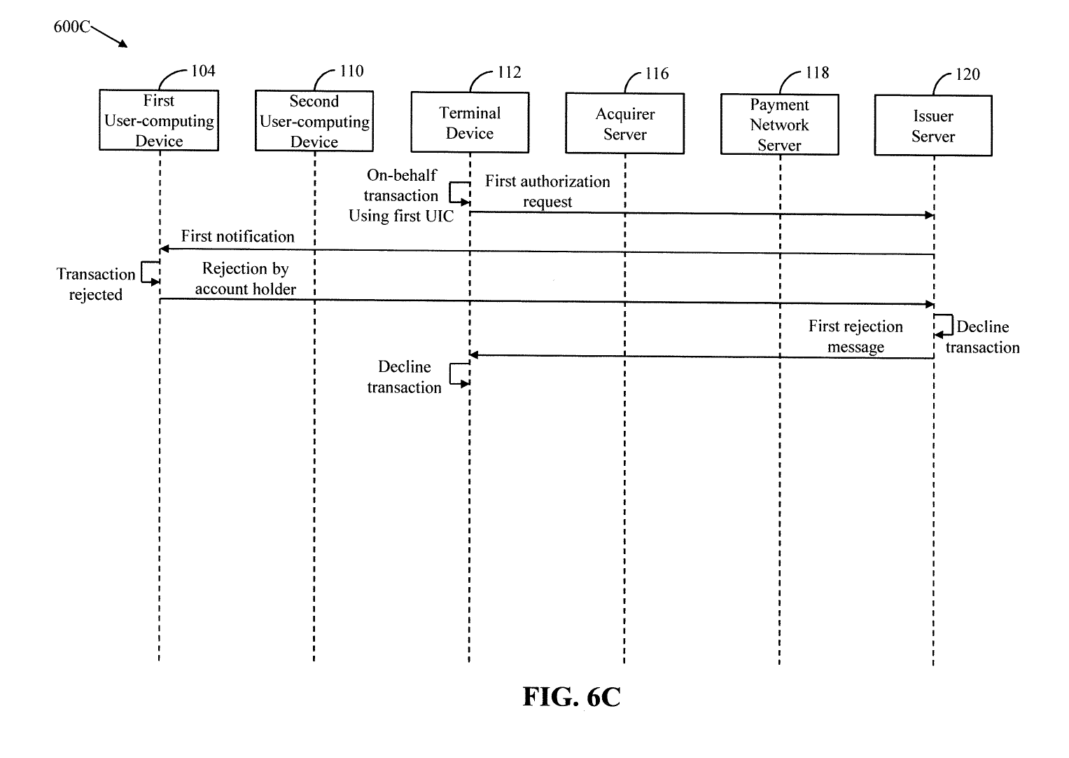

The first transaction manager 216 includes suitable logic, circuitry, and/or interfaces for processing transactions based on the corresponding transaction requests. The first transaction manager 216 captures a transaction, when an account holder's available credit line or account balance covers a transaction amount of the transaction. The first transaction manager 216 declines the transaction, when the account holder's available credit line or the account balance fails to cover the transaction amount. The functions performed by the issuer server 120 are explained later in detail in conjunction with FIG. 5A, FIG. 5B, and FIGS. 6A-6C.

Referring now to FIG. 3, a block diagram that illustrates the payment network server 118 of the communication environment 100 of FIG. 1, in accordance with another embodiment of the present invention, is shown. The payment network server 118 includes a second processor 302, a second memory 304, and a second transceiver 306 that communicate with each other via a second bus 308. The second processor 302 includes a mapping manager 310, a second authorization manager 312, and a second transaction manager 314.

The second processor 302 includes suitable logic, circuitry, and/or interfaces to execute operations for handling various authorization requests and transaction requests that are received from one or more entities, such as the first and second user-computing devices 104 and 110, the terminal device 112, the merchant server 114, the acquirer server 116, or the issuer server 120. Examples of the second processor 302 include, but are not limited to, an ASIC processor, a RISC processor, a CISC processor, an FPGA, and the like. The second processor 302 authorizes the transactions by way of the mapping manager 310, the second authorization manager 312, and the second transaction manager 314.

The second memory 304 includes suitable logic, circuitry, and/or interfaces to store details of various issuer banks and acquirer banks, which are participating members of the payment network. The second memory 304 stores the account profiles of the accounts for which the participating issuer banks and acquirer banks have issued transaction cards to the corresponding account holders. Examples of the second memory 304 include a RAM, a ROM, a removable storage drive, a HDD, a flash memory, a solid-state memory, and the like. It will be apparent to a person skilled in the art that the scope of the invention is not limited to realizing the second memory 304 in the payment network server 118, as described herein. In other embodiments, the second memory 304 may be realized in form of a database server or a cloud storage working in conjunction with the payment network server 118, without departing from the scope of the invention.

The second transceiver 306 transmits and receives data over the communication network 122 using one or more communication network protocols. The second transceiver 306 transmits/receives various requests and messages to/from at least one of the first and second user-computing devices 104 and 110, the terminal device 112, the merchant server 114, the acquirer server 116, the issuer server 120, or other entities that are pursuant to one or more standards for the interchange of transaction messages, such as the ISO8583 standard. Examples of the second transceiver 306 include, but are not limited to, an antenna, a radio frequency transceiver, a wireless transceiver, a Bluetooth transceiver, an ethernet port, a USB port, or any other device configured to transmit and receive data.

The mapping manager 310 includes suitable logic, circuitry, and/or interfaces for mapping the accounts to the UICs of the corresponding on-behalf payees. The mapping manager 310 further updates the account profiles stored in the second memory 304 based on the mapping.

The second authorization manager 312 includes suitable logic, circuitry, and/or interfaces for authorizing the transactions that are performed by using the UICs and/or the registered contact number of the account holder. The second authorization manager 312 notifies an account holder that an on-behalf payee associated with an account of the account holder has performed a transaction from the account. The second authorization manager 312 authorizes the transaction when the account holder approves the transaction and declines the transaction when the account holder rejects the transaction.

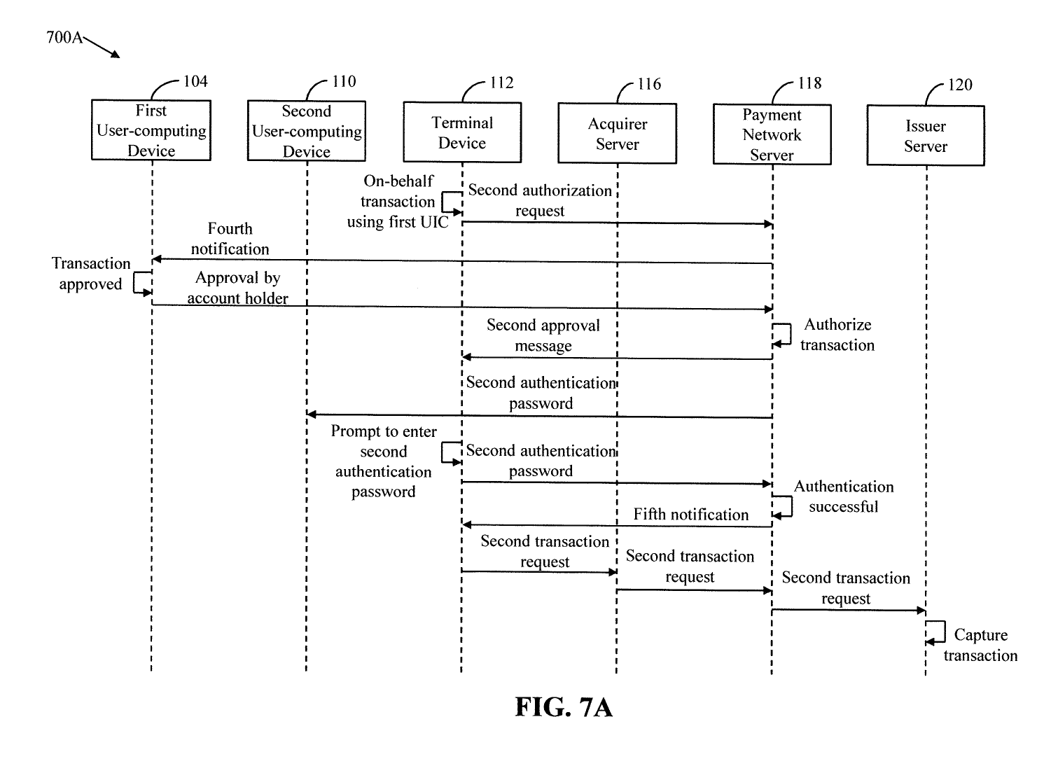

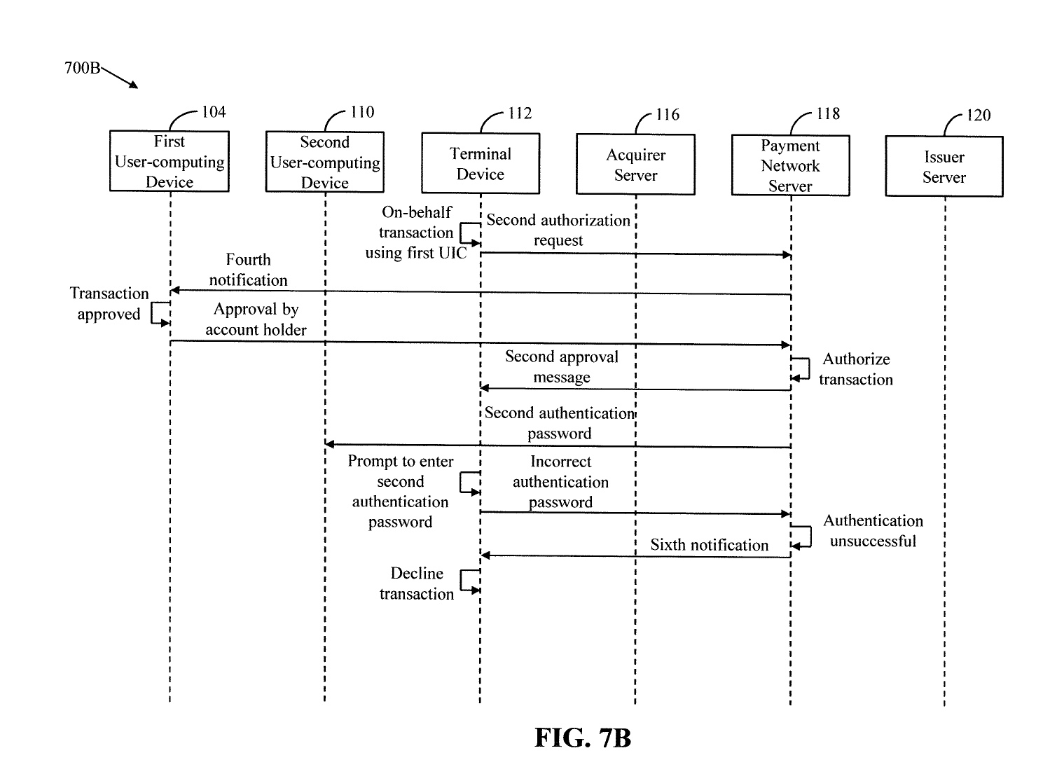

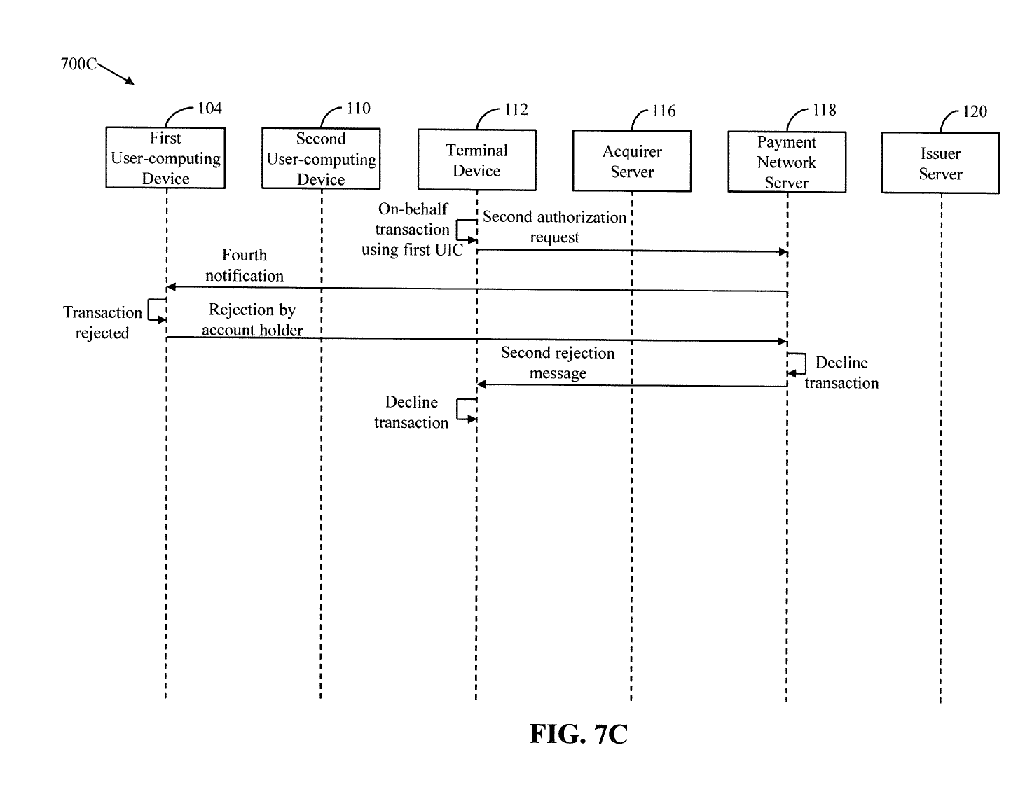

The second transaction manager 314 includes suitable logic, circuitry, and/or interfaces for processing the transaction requests. In one embodiment, based on a transaction request for a transaction, the second transaction manager 314 identifies an issuer bank that maintains an account from which the transaction is to be performed. The second transaction manager 314 then routes the transaction request to the identified issuer bank. The functions performed by the payment network server 118 for authorizing the transactions are explained later in conjunction with FIGS. 7A-7C.

Referring now to FIG. 4, a block diagram that illustrates the merchant server 114 of the communication environment 100 of FIG. 1, in accordance with another embodiment of the present invention, is shown. The merchant server 114 that maintains the e-wallet of the first user 102 includes a third processor 402, a third memory 404, and a third transceiver 406 that communicate with each other via a third bus 408. The third processor 402 includes a second registration manager 410, a second code generator 412, a third authorization manager 414, and a third transaction manager 416.

The third processor 402 includes suitable logic, circuitry, and/or interfaces to execute operations for registering on-behalf payees for e-wallets maintained by the merchant. The third processor 402 further executes the authorization of transactions, such as the on-behalf transactions. Based on the authorization, the third processor 402 processes the transactions for either capturing or declining. Examples of the third processor 402 include, but are not limited to, an ASIC processor, a RISC processor, a CISC processor, an FPGA, and the like. The third processor 402 executes the operations for authorizing and processing transactions by way of the second registration manager 410, the second code generator 412, the third authorization manager 414, and the third transaction manager 416.

The third memory 404 includes suitable logic, circuitry, and/or interfaces to store account profiles for the e-wallets that are maintained by the merchant. Examples of the third memory 404 include a RAM, a ROM, a removable storage drive, a HDD, a flash memory, a solid-state memory, and the like. It will be apparent to a person skilled in the art that the scope of the invention is not limited to realizing the third memory 404 in the merchant server 114, as described herein. In other embodiments, the third memory 404 may be realized in form of a database server or a cloud storage working in conjunction with the merchant server 114, without departing from the scope of the invention.

The third transceiver 406 transmits and receives data over the communication network 122 using one or more communication network protocols. The third transceiver 406 transmits/receives various requests and messages to/from at least one of the first and second user-computing devices 104 and 110, the terminal device 112, the acquirer server 116, the payment network server 118, the issuer server 120, or other entities that are pursuant to one or more standards for the interchange of transaction messages, such as the ISO8583 standard. Examples of the third transceiver 406 include, but are not limited to, an antenna, a radio frequency transceiver, a wireless transceiver, a Bluetooth transceiver, an ethernet port, a USB port, or any other device configured to transmit and receive data.

The second registration manager 410 includes suitable logic, circuitry, and/or interfaces to execute operations for registering the on-behalf payees for the e-wallets maintained by the merchant based on the registration requests raised by the corresponding account holders. The second code generator 412 includes suitable logic, circuitry, and/or interfaces to execute operations for generating UICs for registering the on-behalf payees for the e-wallets.

The third authorization manager 414 includes suitable logic, circuitry, and/or interfaces for authorizing the transactions that are performed from the e-wallets by using the UICs and/or the registered contact number of the account holder. The third authorization manager 414 notifies an account holder, when a corresponding on-behalf payee performs a transaction from the corresponding e-wallet. The third authorization manager 414 authorizes the transaction when the account holder approves the transaction and declines the transaction when the account holder rejects the transaction.

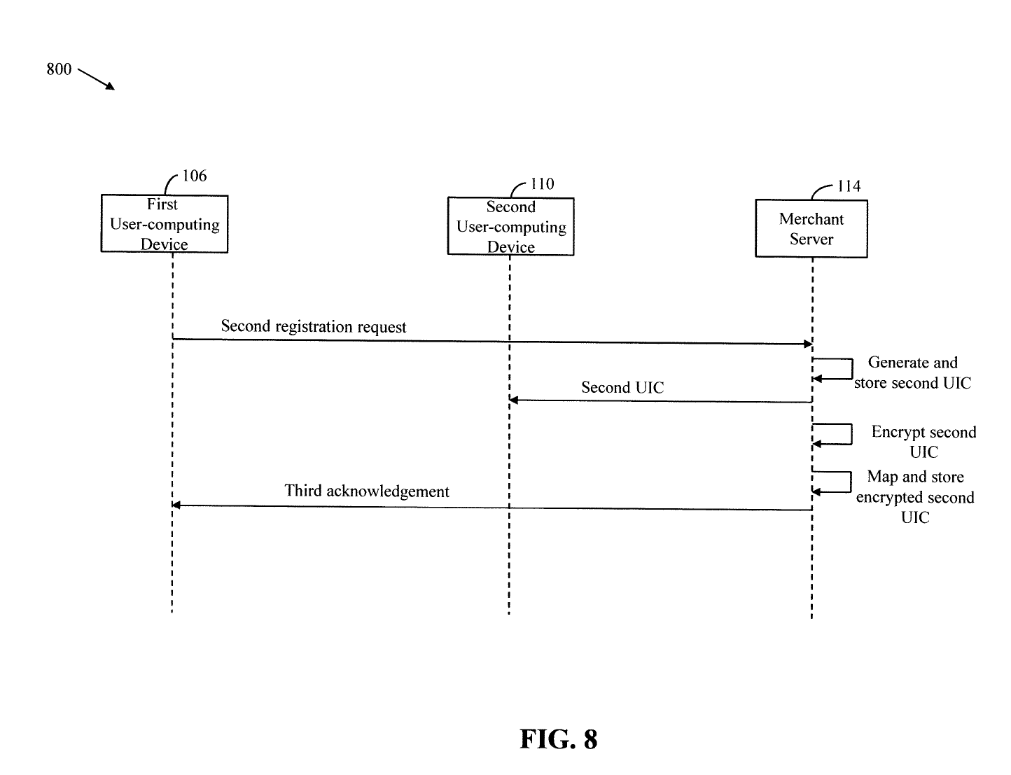

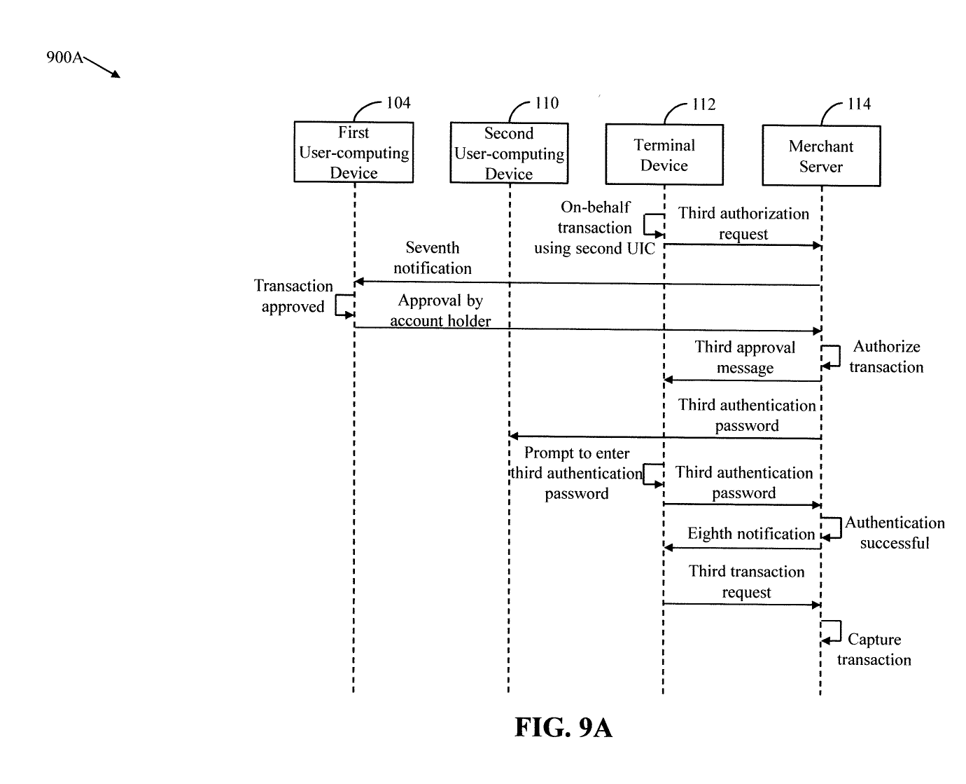

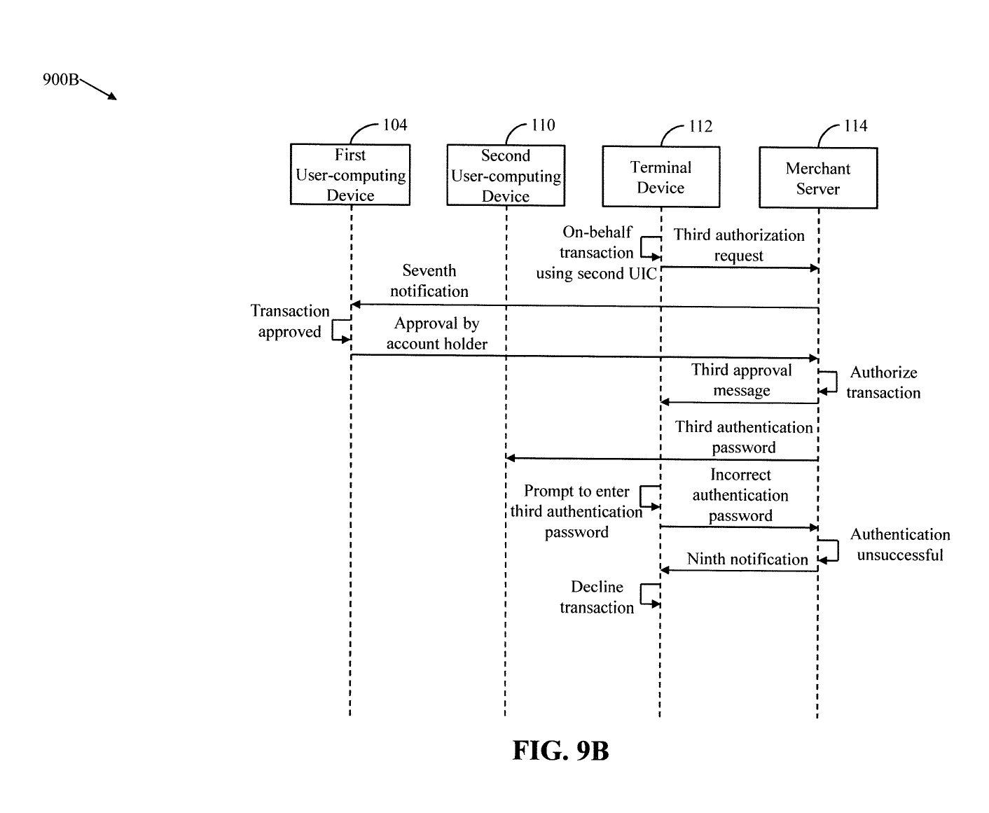

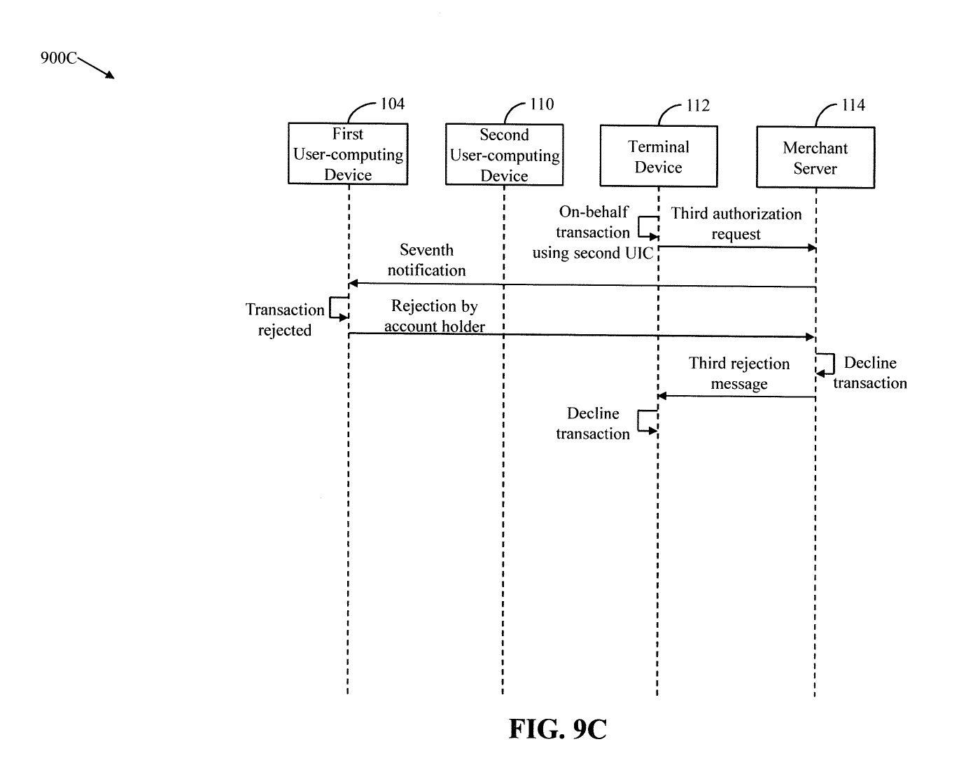

The third transaction manager 416 includes suitable logic, circuitry, and/or interfaces for processing transactions based on the corresponding transaction requests. The third transaction manager 416 captures a transaction, when an e-wallet balance covers a transaction amount of the transaction and declines the transaction, when the e-wallet balance fails to cover the transaction amount. The functions performed by the merchant server 114 are explained later in detail in conjunction with FIG. 8 and FIGS. 9A-9C.

Referring now to FIG. 5A, a process flow diagram 500 that illustrates an exemplary scenario for registering the second user 108 as an on-behalf payee for the first account of the first user 102, in accordance with an embodiment of the present invention, is shown.

The first user 102 uses the first user-computing device 104 for registering the second user 108 as the on-behalf payee for the first account. In one embodiment, for registering the second user 108, the first user 102 raises a first registration request by accessing a website of the issuer bank. In another embodiment, the first user 102 raises the first registration request by accessing a mobile application of the issuer bank that is installed on the first user-computing device 104. The first user 102 provides contact information, name, age, and the like of the second user 108 for initiating the first registration request. The contact information of the second user 108 includes the contact number and the e-mail ID of the second user 108. The first transceiver 206 receives the first registration request. The first registration manager 210 initiates the registration of the second user 108 as the on-behalf payee for the first account based on the first registration request.

The first registration manager 210 instructs the first code generator 212 to generate a first UIC for registering the second user 108 as the on-behalf payee for the first account. In one scenario, the first code generator 212 generates the first UIC based on the contact number of the second user 108, a timestamp associated with the first registration request, the BIN of the issuer bank, and the payment-network identification number of the payment network. The timestamp associated with the first registration request indicates a time instance at which the first user 102 had raised the first registration request. For example, the first user 102 raises the first registration request on Feb. 12, 2018 at 11 AM. In this scenario, the timestamp associated with the first registration request is 02122018110000 (i.e., in MMDDYYHHMMSS format).

In one example, the first UIC is a 10 digit unique number. The first code generator 212 assigns the first two digits (for example, “02”) of the timestamp as the first two digits of the first UIC. The first code generator 212 further assigns the last four digits of the contact number of the second user 108 (for example, “9877”) as the third through sixth digits of the first UIC. The first code generator 212 further assigns the BIN (for example, “4”) and the payment-network identification number (for example, “5”) as the seventh and eighth digits of the first UIC, respectively. The first code generator 212 further assigns two random digits (for example, “09”) as the ninth and tenth digits of the first UIC. Thus, the first UIC generated by the first code generator 212 for registering the second user 108 as the on-behalf payee of the first account is “0298774509”.

It will be apparent to a person ordinarily skilled in the art that the abovementioned example for the generation of the first UIC is for illustrative purpose. In other embodiments, the first code generator 212 may generate the first UIC by using any other methodology that is scalable and ensures that each UIC is unique. The first UIC may have any number of digits without departing from the scope of the invention.

The first registration manager 210 retrieves the account profile of the first account from the first memory 204 and updates the account profile by including the first UIC therein. The first registration manager 210 communicates the first UIC to the second user 108 by way of the contact information. In one example, the first registration manager 210, in conjunction with the first transceiver 206, transmits a short message service (SMS) on the contact number of the second user 108 for communicating the first UIC to the second user 108. In another example, the first registration manager 210 sends an e-mail on the e-mail ID of the second user 108 for communicating the first UIC to the second user 108. In yet another example, the first registration manager 210 initiates an interactive voice response (IVR) call on the contact number of the second user 108 for communicating the first UIC to the second user 108.

The first registration manager 210 encrypts the first UIC and transmits the encrypted first UIC to the payment network server 118. In one embodiment, the first registration manager 210 also encrypts and transmits the contact number and the e-mail ID of the second user 108, and the account number of the first account to the payment network server 118. The second transceiver 306 receives the encrypted first UIC, the encrypted contact number, the encrypted e-mail ID, and the encrypted account number.

The mapping manager 310 decrypts the encrypted account number and retrieves the account profile of the first account from the second memory 304 based on the decrypted account number. The mapping manager 310 maps the encrypted first UIC, the encrypted contact number, and the encrypted e-mail ID to the account profile of the first account. In other words, the mapping manager 310 maps the first account to the encrypted first UIC, the encrypted contact number, and the encrypted e-mail ID. An example of an updated account profile of the first account that is mapped to the encrypted first UIC, the encrypted contact number, and the encrypted e-mail ID is shown by way of Table 502 in FIG. 5B. The mapping manager 310 transmits a first acknowledgement to the issuer server 120 to indicate a successful mapping of the first UIC to the first account. The first transceiver 206 receives the first acknowledgement and transmits a second acknowledgement to the first user-computing device 104 for indicating a successful registration of the second user 108 as the on-behalf payee of the first account. Examples of the second acknowledgement include, but are not limited to, an SMS, an e-mail, an IVR call, a push notification, or the like. After registration, the second user 108 is authorized to perform on-behalf transactions from the first account by using the first UIC.

In one embodiment, the first user 102 may register multiple users as on-behalf payees for the first account. In such a scenario, each on-behalf payee of the first account has a different UIC and the first account is mapped to each UIC. In another embodiment, the first user 102 may possess another transaction card (not shown) linked to the first account. In such a scenario, the first user 102 has to specify the card number of the transaction card 106 or the other transaction card while initiating the first registration request. Thus, the second user 108 is registered as the on-behalf payee for the first account and the first UIC is mapped to at least one of the transaction card 106 and the other transaction card that is specified by the first user 102 in the first registration request.

Referring now to FIGS. 6A-6C, process flow diagrams 600A-600C that illustrate exemplary scenarios for authorizing on-behalf transactions, in accordance with an embodiment of the present invention, are shown.

With reference to FIG. 6A, the process flow diagram 600A illustrates the first and second user-computing devices 104 and 110, the terminal device 112, the acquirer server 116, the payment network server 118, and the issuer server 120. The second user 108 selects the on-behalf transaction option presented on the terminal device 112 for performing a first transaction (i.e., the on-behalf transaction). Thus, the second user 108 provides the first UIC at the terminal device 112 for performing the first transaction from the first account. The second user 108 also provides the registered contact information (such as the registered contact number or the registered e-mail ID) of the first user 102 (i.e., the account holder) to the terminal device 112 for performing the first transaction from the first account. In other words, the second user 108 performs the first transaction from the first account without using the transaction card 106 linked to the first account.

In one embodiment, based on the BIN included in the first UIC, the terminal device 112 identifies the issuer bank that maintains the first account and transmits a first authorization request to the issuer server 120 of the identified issuer bank. The terminal device 112 transmits the authorization request to the issuer server 120 of the identified issuer bank by using a DTMF code or an API. The authorization request includes data fields that are pursuant to one or more standards for the interchange of transaction messages, such as the ISO8583 standard. The data fields include the first UIC, a transaction amount of the first transaction, the registered contact information, a merchant identification code of the merchant store where the terminal device 112 is installed, or the like. In another embodiment, the terminal device 112 transmits the first authorization request using, for example, a DTMF code to the acquirer server 116 of the acquirer bank that controls the terminal device 112. The acquirer server 116 then transmits the first authorization request to the issuer server 120 based on the BIN included in the first UIC. In yet another embodiment, one of the terminal device 112 or the acquirer server 116 transmits the first authorization request to the payment network server 118 based on the payment-network identification number. The payment network server 118 then transmits the first authorization request to the issuer server 120 based on the BIN included in the first UIC.

The first transceiver 206 receives the first authorization request. Based on the registered contact information included in the first authorization request, the first authorization manager 214 identifies the first account from which the first transaction is performed. The first authorization manager 214 retrieves the account profile of the first account from the first memory 204. The first authorization manager 214 compares the first UIC included in the first authorization request with the first UIC included in the account profile to verify whether the first UIC used to perform the first transaction is valid or invalid. When the first authorization manager 214 determines that the first UIC is invalid, the first authorization manager 214 declines the first transaction and notifies the second user 108 through the terminal device 112 to perform the first transaction again by re-entering the first UIC. When the first authorization manager 214 determines that the first UIC is valid, the first authorization manager 214 generates a first notification to notify the first user 102 that the second user 108 has performed the first transaction from the first account. The first notification includes the details of the second user 108, a transaction amount of the first transaction, details of the merchant store, and the like. The details of the second user 108 include the name, the contact information, and the like of the second user 108. The first transceiver 206 transmits the first notification to the first user-computing device 104 by way of the registered contact information of the first user 102.

The first user-computing device 104 receives the first notification as an SMS, an IVR call, or an e-mail. In another example, the first user-computing device 104 receives the first notification as a push notification by way of the mobile application of the issuer bank or by using any other notification means known in the art.

The first user 102 may either approve or reject the first transaction by providing a response to the first notification. The process flow diagram 600A illustrates the scenario when the first user 102 provides the response to approve the first transaction. The first user 102 may provide the response by sending an SMS or an e-mail to the issuer server 120. The first user 102 may also provide the response during the IVR call. In another example, the first user 102 provides the response by accepting the push notification or by any other mechanism known in the art.

The first user-computing device 104 transmits the response that indicates the approval of the first transaction to the issuer server 120. The first transceiver 206 receives the response. The first authorization manager 214 authorizes the first transaction and transmits a first approval message to the terminal device 112. In another embodiment, the first authorization manager 214 transmits the first approval message to the acquirer server 116, which communicates the first approval message to the terminal device 112. In yet another embodiment, the first authorization manager 214 transmits the first approval message to the payment network server 118 and the payment network server 118 communicates the first approval message to the terminal device 112 by way of the acquirer server 116.

In one embodiment, the first authorization manager 214 authenticates the second user 108. For authenticating the second user 108, the first authorization manager 214 generates a first authentication password and communicates the first authentication password to the second user 108 by way of the contact information of the second user 108. Examples of the first authentication password include, but are not limited to, an OTP, a 3D secure password, a QR code, or a combination thereof. The second user-computing device 110 that is linked to the contact information receives the first authentication password and presents the first authentication password to the second user 108.

The terminal device 112 receives the first approval message and prompts the second user 108 to provide the first authentication password. The second user 108 may either provide a correct authentication password (i.e., the first authentication password) or an incorrect authentication password. The process flow diagram 600A illustrates the scenario when the second user 108 provides the correct authentication password to the terminal device 112. The terminal device 112 communicates the first authentication password to the issuer server 120 by way of the acquirer server 116.

The first transceiver 206 receives the first authentication password. Since the second user 108 had provided the correct authentication password, the first authorization manager 214 determines that the authentication is successful. The first authorization manager 214 authorizes the first transaction, when the authentication is successful. The first authorization manager 214 generates a second notification to indicate that the authentication of the second user 108 is successful. The second notification includes the account identification information of the first account, such as the account number, the card number of the transaction card 106, and the like. The first transceiver 206 transmits the second notification to the terminal device 112. Based on the second notification, the terminal device 112 processes the first transaction.

The terminal device 112 transmits a first transaction request to the acquirer server 116. The first transaction request includes one or other data fields (for example, the transaction amount, the account number of the first account, and the like) that are pursuant to the standards for the interchange of transaction messages, such as the ISO8583 standard. The acquirer server 116 transmits the first transaction request to the payment network server 118, which in turn transmits the first transaction request to the issuer server 120.

The first transceiver 206 receives the first transaction request. The first transaction manager 216 processes the first transaction for capturing or declining based on the first transaction request. The first transaction manager 216 captures the first transaction, when the account holder's available credit line or account balance covers the transaction amount. The transaction amount is then deducted from the first account and credited to a merchant account. The first transaction manager 216 notifies the first and second users 102 and 108 that the first transaction is captured. In another scenario, when the terminal device 112 is an ATM, the transaction amount is deducted from the first account and the second user 108 receives a cash equivalent to the transaction amount at the terminal device 112. In an alternate scenario, when the account holder's available credit line or account balance fails to cover the transaction amount, the first transaction manager 216 declines the first transaction. The first transaction manager 216 notifies the first and second users 102 and 108 that the first transaction is declined.

In another embodiment, the second user 108 may access a merchant website or a mobile application of the merchant on the second user-computing device 110 for performing the first transaction. In such a scenario, the merchant server 114 generates the authorization request and the functionalities of the terminal device 112 are performed by the merchant server 114 in conjunction with the second user-computing device 110.

With reference to FIG. 6B, the process flow diagram 600B illustrates the scenario when the second user 108 provides the incorrect authentication password to the terminal device 112. The terminal device 112 communicates the incorrect authentication password to the issuer server 120.

The first transceiver 206 receives the incorrect authentication password. The first authorization manager 214 determines that the authentication is unsuccessful based on the incorrect authentication password and declines the first transaction. The first authorization manager 214 generates and transmits a third notification to the terminal device 112. The third notification indicates that the authentication of the second user 108 is unsuccessful. The terminal device 112 declines the first transaction based on the third notification. The terminal device 112 displays a message to the second user 108 that the first transaction is declined due to the incorrect authentication password. The first transaction manager 216 further notifies the first user 102 that the first transaction is declined due to unsuccessful authentication.

With reference to FIG. 6C, the process flow diagram 600C illustrates the scenario when the first user 102 provides the response to reject the first transaction. The first user-computing device 104 transmits the response that indicates the rejection of the first transaction by the first user 102 to the issuer server 120. The first transceiver 206 receives the response. The first authorization manager 214 declines the first transaction and transmits a first rejection message to the terminal device 112 based on the rejection of the first transaction. In another embodiment, the first authorization manager 214 transmits the first rejection message to the acquirer server 116, which communicates the first rejection message to the terminal device 112. In yet another embodiment, the first authorization manager 214 transmits the first rejection message to the payment network server 118 and the payment network server 118 communicates the first rejection message to the terminal device 112 by way of the acquirer server 116.

The terminal device 112 declines the first transaction based on the first rejection message. The terminal device 112 displays a message to the second user 108 that the first transaction is declined due to the rejection by the first user 102. The first transaction manager 216 further notifies the first user 102 that the first transaction is declined.

Referring now to FIGS. 7A-7C, process flow diagrams 700A-700C that illustrate exemplary scenarios for authorizing on-behalf transactions, in accordance with another embodiment of the present invention, are shown.

With reference to FIG. 7A, the process flow diagram 700A illustrates the first and second user-computing devices 104 and 110, the terminal device 112, the acquirer server 116, the payment network server 118, and the issuer server 120. The second user 108 performs a second transaction (i.e., the on-behalf transaction) from the first account by using the first UIC at the terminal device 112. The second user 108 also provides the registered contact information of the first user 102 to the terminal device 112.

In one embodiment, based on the payment-network identification number included in the first UIC, the terminal device 112 identifies the payment network and transmits a second authorization request to the payment network server 118. In another embodiment, the terminal device 112 transmits the second authorization request to the acquirer server 116, which in turn transmits the second authorization request to the payment network server 118. The terminal device 112 transmits the authorization request to the payment network server 118 or the acquirer server 116 by using a DTMF code or an API.

The second transceiver 306 receives the second authorization request. Based on the registered contact information included in the second authorization request, the second authorization manager 312 identifies the first account from which the second transaction is performed. The second authorization manager 312 retrieves the account profile of the first account from the second memory 304 and compares the first UIC included in the second authorization request with the first UIC included in the account profile to verify whether the first UIC used to perform the second transaction is valid or invalid. When the first UIC is invalid, the second authorization manager 312 declines the second transaction and notifies the second user 108 through the terminal device 112 to perform the second transaction again by re-entering the first UIC. Conversely, when the first UIC is valid, the second authorization manager 312 generates and transmits a fourth notification to notify the first user 102 that the second user 108 has performed the second transaction from the first account. The first user 102 is notified by way of the registered contact information.

The first user-computing device 104 receives the fourth notification. The process flow diagram 700A illustrates the scenario when the first user 102 provides the response to approve the second transaction. The first user-computing device 104 transmits the response indicating the approval of the second transaction to the payment network server 118. The second transceiver 306 receives the response. Based on the approval of the second transaction, the second authorization manager 312 authorizes the second transaction and transmits a second approval message to the terminal device 112. In another embodiment, the second authorization manager 312 transmits the second approval message to the acquirer server 116, which communicates the second approval message to the terminal device 112.

Based on the second approval message, the second authorization manager 312 further performs the authentication of the second user 108 by generating a second authentication password. The second authorization manager 312 communicates the second authentication password to the second user 108 by way of the contact information of the second user 108. The second user-computing device 110 that is linked to the contact information receives the second authentication password and presents the second authentication password to the second user 108.

The terminal device 112 receives the second approval message and prompts the second user 108 to provide the second authentication password. The second user 108 may either provide the correct authentication password (i.e., the second authentication password) or the incorrect authentication password. The process flow diagram 700A illustrates the scenario when the second user 108 provides the correct authentication password to the terminal device 112. The terminal device 112 communicates the second authentication password to the payment network server 118.

The second transceiver 306 receives the second authentication password. Since the second user 108 had provided the correct authentication, the authentication is successful and the second authorization manager 312 authorizes the second transaction. The second authorization manager 312 generates a fifth notification to indicate the successful authentication of the second user 108. The fifth notification includes the account identification information of the first account, such as the account number, the card number of the transaction card 106, and the like. The second transceiver 306 transmits the fifth notification to the terminal device 112. The terminal device 112 processes the second transaction based on the fifth notification.

The terminal device 112 transmits a second transaction request including the account identification information of the first account to the acquirer server 116. The acquirer server 116 transmits the second transaction request to the payment network server 118. The second transceiver 306 receives the second transaction request. Based on the account identification information, the second transaction manager 314 identifies the issuer bank that maintains the first account. The second transceiver 306 then transmits the second transaction request to the issuer server 120 of the identified issuer bank. The first transceiver 206 receives the second transaction request and the first transaction manager 216 processes the second transaction for either capture or decline based on the account holder's available credit line or account balance as described in the foregoing.

With reference to FIG. 7B, the process flow diagram 700B illustrates the scenario when the second user 108 provides the incorrect authentication password to the terminal device 112. The terminal device 112 communicates the incorrect authentication password to the payment network server 118. The second transceiver 306 receives the incorrect authentication password. Based on the incorrect authentication password, the second authorization manager 312 determines that the authentication is unsuccessful and declines the second transaction. The second authorization manager 312 generates and transmits a sixth notification to the terminal device 112 for indicating that the authentication of the second user 108 was unsuccessful. The terminal device 112 declines the second transaction and notifies the second user 108 that the second transaction is declined, based on the sixth notification. The second authorization manager 312 further notifies the first user 102 that the second transaction is declined due to unsuccessful authentication.

With reference to FIG. 7C, the process flow diagram 700C illustrates the scenario when the first user 102 provides the response to reject the second transaction. The first user-computing device 104 transmits the response that indicates the rejection of the second transaction to the payment network server 118. The second transceiver 306 receives the response. The second authorization manager 312 declines the second transaction and transmits a second rejection message to the terminal device 112. In another embodiment, the second authorization manager 312 transmits the second rejection message to the acquirer server 116, which communicates the second rejection message to the terminal device 112. The terminal device 112 declines the second transaction based on the second rejection message. The terminal device 112 displays a message to the second user 108 that the second transaction is declined. The second authorization manager 312 further notifies the first user 102 that the second transaction is declined.

Referring now to FIG. 8, a process flow diagram 800 that illustrates an exemplary scenario for registering the second user 108 as an on-behalf payee for the e-wallet of the first user 102, in accordance with an embodiment of the present invention, is shown. The merchant server 114 maintains the e-wallet of the first user 102.

The first user 102 uses the first user-computing device 104 for registering the second user 108 as the on-behalf payee for the e-wallet. In one embodiment, for registering the second user 108, the first user 102 raises a second registration request by accessing the website associated with the e-wallet on the first user-computing device 104. In another embodiment, the first user 102 raises the second registration request by accessing the mobile application of the e-wallet that is installed on the first user-computing device 104. The first user 102 provides the contact information, name, age, and the like of the second user 108 for initiating the second registration request. The third transceiver 406 receives the second registration request. The second registration manager 410 initiates the registration of the second user 108 as the on-behalf payee of the e-wallet based on the second registration request.

The second registration manager 410 instructs the second code generator 412 to generate a second UIC for registering the second user 108 as the on-behalf payee of the e-wallet. The second code generator 412 uses a merchant identification code associated with the merchant for generating the second UIC. The second code generator 412 generates the second UIC in a similar manner as described in conjunction with FIG. 5A. The second registration manager 410 communicates the second UIC to the second user 108 by way of the contact information. The second registration manager 410 encrypts the second UIC, the contact number, and the e-mail ID of the second user 108 and maps the encrypted second UIC, the encrypted contact number, and the encrypted e-mail ID to the account profile of the e-wallet. The third transceiver 406 transmits a third acknowledgement to the first user-computing device 104 for indicating a successful registration of the second user 108 as the on-behalf payee of the e-wallet. Examples of the third acknowledgement include, but are not limited to, an SMS, an e-mail, an IVR call, a push notification, or the like. After registration, the second user 108 is authorized to perform the on-behalf transactions from the e-wallet by using the second UIC.

In one embodiment, the first user 102 may register multiple users as on-behalf payees for the e-wallet. In such a scenario, each on-behalf payee of the e-wallet has a different UIC and the e-wallet is mapped to each UIC.

Referring now to FIGS. 9A-9C, process flow diagrams 900A-900C that illustrate exemplary scenarios for authorizing on-behalf transactions that are performed from e-wallets, in accordance with another embodiment of the present invention, are shown.

With reference to FIG. 9A, the process flow diagram 900A illustrates the first and second user-computing devices 104 and 110, the terminal device 112, and the merchant server 114 that maintains the e-wallet of the first user 102. The second user 108 selects the on-behalf transaction option presented on the terminal device 112 and provides the second UIC for performing a third transaction (i.e., the on-behalf transaction) from the e-wallet of the first user 102. The second user 108 further provides the registered contact information of the first user 102 to the terminal device 112. In other words, the second user 108 performs the third transaction from the e-wallet of the first user 102 without using the first user-computing devices 104 linked to the e-wallet.

The terminal device 112 identifies the merchant that maintains the e-wallet based on the merchant identification code in the second UIC and transmits a third authorization request to the merchant server 114. The third authorization request includes the second UIC, a transaction amount of the third transaction, the registered contact information, or the like. The third transceiver 406 receives the third authorization request. Based on the registered contact information included in the third authorization request, the third authorization manager 414 identifies the e-wallet from which the third transaction is performed. The third authorization manager 414 retrieves the account profile of the e-wallet from the third memory 404 and compares the second UIC included in the third authorization request with the second UIC included in the account profile to verify whether the second UIC used to perform the third transaction is valid or invalid. When the third UIC is invalid, the third authorization manager 414 declines the third transaction and notifies the second user 108 through the terminal device 112 to perform the third transaction again by re-entering the second UIC. Conversely, when the second UIC is valid, the third authorization manager 414 generates a seventh notification to notify the first user 102 that the second user 108 has performed the third transaction from the e-wallet. The third transceiver 406 transmits the seventh notification to the first user-computing device 104 by way of the registered contact information of the first user 102.

The first user-computing device 104 receives the seventh notification. The process flow diagram 900A illustrates the scenario when the first user 102 provides the response to approve the third transaction. The first user-computing device 104 transmits the response that indicates the approval of the third transaction to the merchant server 114. The third transceiver 406 receives the response. The third authorization manager 414 authorizes the third transaction and transmits a third approval message to the terminal device 112. The third authorization manager 414 generates a third authentication password for authenticating the second user 108 and communicates the third authentication password to the second user 108 by way of the contact information of the second user 108. The second user-computing device 110 receives and presents the third authentication password to the second user 108.

The terminal device 112 receives the third approval message and prompts the second user 108 to provide the third authentication password. The process flow diagram 900A illustrates the scenario when the second user 108 provides the correct authentication password. The terminal device 112 communicates the third authentication password to the merchant server 114. The third transceiver 406 receives the third authentication password. Based on the correct authentication password, the third authorization manager 414 determines that the authentication is successful and authorizes the third transaction. The third authorization manager 414 generates an eighth notification to indicate that the authentication of the second user 108 is successful. The third transceiver 406 transmits the eighth notification to the terminal device 112 and the terminal device 112 processes the third transaction based on the eighth notification.

The terminal device 112 transmits a third transaction request to the merchant server 114. The third transceiver 406 receives the third transaction request. The third transaction manager 416 processes the third transaction for capturing or declining based on the third transaction request. The third transaction manager 416 captures the third transaction, when the e-wallet balance covers the transaction amount. The transaction amount is then deducted from the e-wallet. The third transaction manager 416 notifies the first and second users 102 and 108 that the third transaction is captured. In an alternate scenario, when the e-wallet balance fails to cover the transaction amount, the third transaction manager 416 declines the third transaction. The third transaction manager 416 notifies the first and second users 102 and 108 that the third transaction is declined. In another embodiment, the second user 108 may perform the on-behalf transaction by accessing a merchant website on the second user-computing device 110.

With reference to FIG. 9B, the process flow diagram 900B illustrates the scenario when the second user 108 provides the incorrect authentication password to the terminal device 112. Based on the incorrect authentication password, the third authorization manager 414 determines that the authentication is unsuccessful and declines the third transaction. The third authorization manager 414 generates and transmits a ninth notification to the terminal device 112 for indicating the decline of the third transaction. The terminal device 112 declines the third transaction based on the ninth notification.

With reference to FIG. 9C, the process flow diagram 900C illustrates the scenario when the first user 102 provides the response to reject the third transaction. The first user-computing device 104 transmits the response that indicates the rejection of the third transaction to the merchant server 114. The third transceiver 406 receives the response. The third authorization manager 414 declines the third transaction and transmits a third rejection message to the terminal device 112. The terminal device 112 declines the third transaction based on the third rejection message.

It will be apparent to one skilled in the art that instead of the merchant server 114 a third-party server (not shown) may maintain the e-wallet of the first user 102. In such a scenario, the third-party server is implemented by the block diagram of FIG. 4 and the third-party server authorizes the on-behalf transactions as described in FIGS. 9A-9C. In other embodiments, the authentication of the second user 108 by way of the first through third authentication passwords may be optional.

Thus, the payment network server 118 and the issuer server 120 enable the first user 102 (i.e., the account holder) to register multiple on-behalf payees (for example, the second user 108) for the first account. Similarly, the merchant server 114 enables the first user 102 to register the on-behalf payees for the e-wallet maintained by the merchant server 114. The merchant server 114, the payment network server 118, and the issuer server 120 allow the second user 108 to perform on-behalf transactions from the first account and the e-wallet by using the corresponding UIC based on consent of the first user 102. Hence, the merchant server 114, the payment network server 118, and the issuer server 120 of the present invention eliminates the need for the second user 108 to have a bank account, a transaction card linked to the bank account, or an e-wallet hosted on a smartphone for performing transactions. The authentication performed by the merchant server 114, the payment network server 118, and the issuer server 120 makes the authorization of the on-behalf transactions more secure. Thus, if another user performs a fraudulent on-behalf transaction by using the first or second UIC, the authentication fails as the authentication password is communicated to the second user 108 on her contact information only.

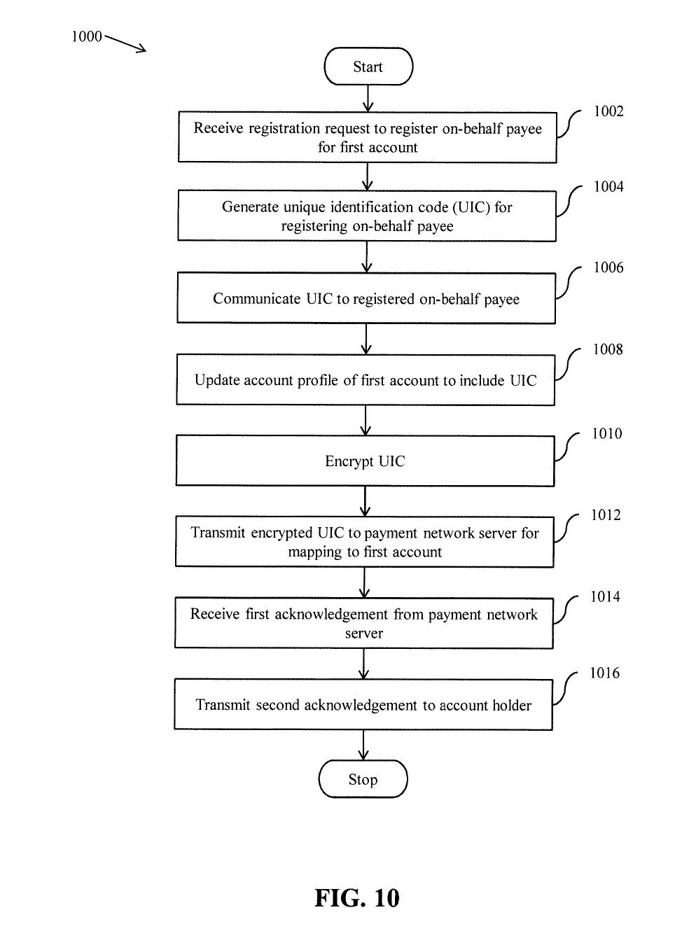

Referring now to FIG. 10, a flow chart 1000 that illustrates the method for registering an on-behalf payee for the first account of the first user 102, in accordance with an embodiment of the present invention, is shown.

At step 1002, the first transceiver 206 receives the first registration request to register the second user 108 as the on-behalf payee for the first account. At step 1004, the first code generator 212 generates the first UIC for registering the on-behalf payee for the first account. At step 1006, the first transceiver 206 communicates the first UIC to the registered on-behalf payee (i.e., the second user 108) by way of the contact information of the registered on-behalf payee. At step 1008, the first registration manager 210 updates the account profile of the first account to include the first UIC. At step 1010, the first registration manager 210 encrypts the first UIC. At step 1012, the first transceiver 206 transmits the encrypted first UIC to the payment network server 118 for mapping to the first account. The payment network server 118 maps the encrypted first UIC to the first account as shown in conjunction with Table 502. At step 1014, the first transceiver 206 receives the first acknowledgement from the payment network server 118 indicating that the first UIC is successfully mapped to the first account. At step 1016, the first transceiver 206 transmits the second acknowledgement to the first user 102 (i.e., the account holder) indicating the second user 108 is successfully registered as the on-behalf payee for the first account.

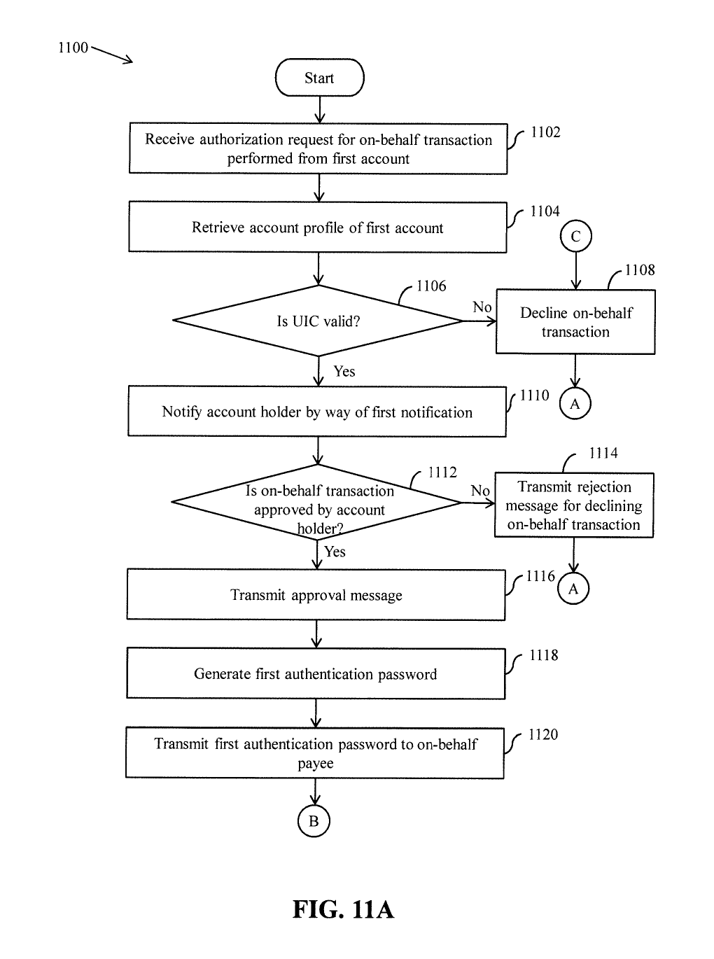

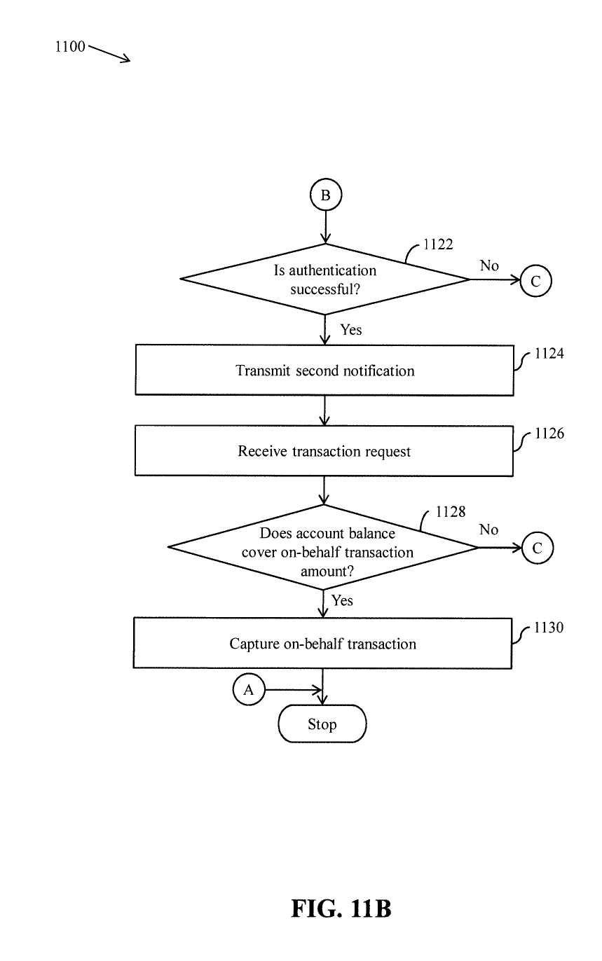

Referring now to FIGS. 11A and 11B, a flow chart 1100 that illustrates the method for authorizing an on-behalf transaction, in accordance with an embodiment of the present invention, is shown. At step 1102, the first transceiver 206 receives the first authorization request for the on-behalf transaction performed from the first account by the second user 108. The second user 108 performs the on-behalf transaction by using the first UIC. At step 1104, the first authorization manager 214 retrieves the account profile of the first account based on the first authorization request. At step 1106, the first authorization manager 214 determines whether the first UIC included in the first authorization request is valid or invalid. If at step 1106, it is determined that the first UIC is invalid, step 1108 is performed. At step 1108, the first transaction manager 216 declines the on-behalf transaction. If at step 1106, it is determined that the first UIC is valid, step 1110 is performed.

At step 1110, the first authorization manager 214, in conjunction with the first transceiver 206, notifies the first user 102 (i.e., the account holder) by way of the first notification that the second user 108 has performed the on-behalf transaction from the first account. At step 1112, the first authorization manager 214 determines whether the on-behalf transaction is approved by the first user 102 (i.e., the account holder). If at step 1112, it is determined that the on-behalf transaction is not approved by the first user 102, step 1114 is performed. At step 1114, the first transceiver 206, in conjunction with the first authorization manager 214, transmits the first rejection message for declining the on-behalf transaction. If at step 1112, it is determined that the on-behalf transaction is approved by the first user 102, step 1116 is performed. At step 1116, the first transceiver 206, in conjunction with the first authorization manager 214, transmits the first approval message to one of the terminal device 112 or the second user-computing device 110. At step 1118, the first authorization manager 214 generates the first authentication password. At step 1120, the first transceiver 206 transmits the first authentication password to the second user 108 (i.e., the on-behalf payee) by way of the contact information of the second user 108.

At step 1122, the first authorization manager 214 determines whether the authentication of the second user 108 is successful or unsuccessful. If at step 1122, it is determined that the authentication is unsuccessful, step 1108 is performed. If at step 1122, it is determined that the authentication is successful, step 1124 is performed. At step 1124, the first transceiver 206, in conjunction with the first authorization manager 214, transmits the second notification for indicating a successful authentication of the second user 108. At step 1126, the first transceiver 206 receives the first transaction request for processing the on-behalf transaction. At step 1128, the first transaction manager 216 determines whether the account balance of the first account covers an on-behalf transaction amount of the on-behalf transaction. If at step 1128, it is determined that the account balance of the first account does not cover the on-behalf transaction amount, step 1108 is performed. If at step 1128, it is determined that the account balance of the first account covers the on-behalf transaction amount, step 1130 is performed. At step 1130, the first transaction manager 216 captures the on-behalf transaction.

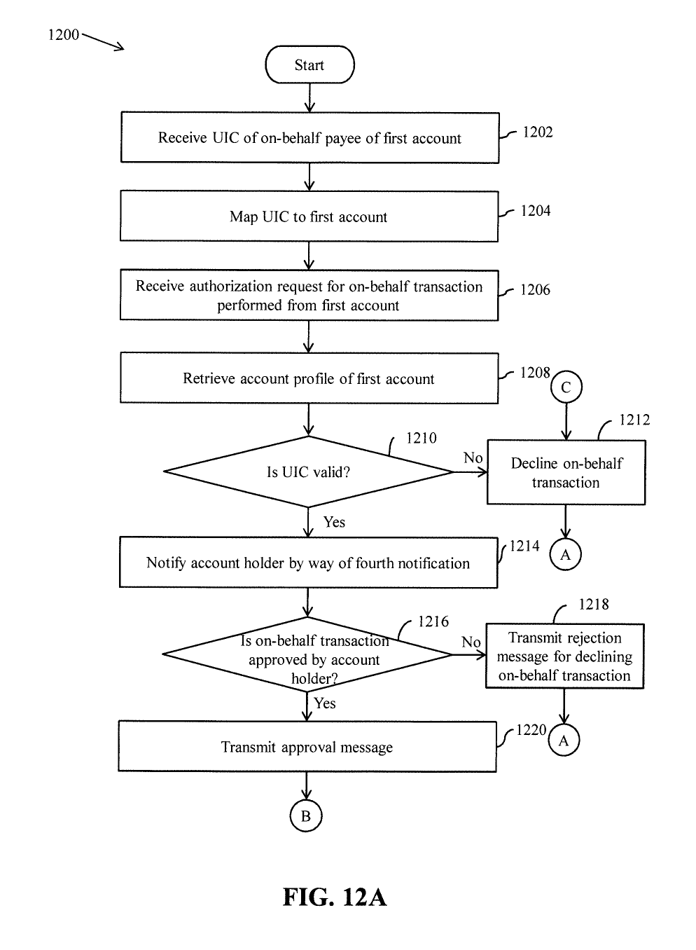

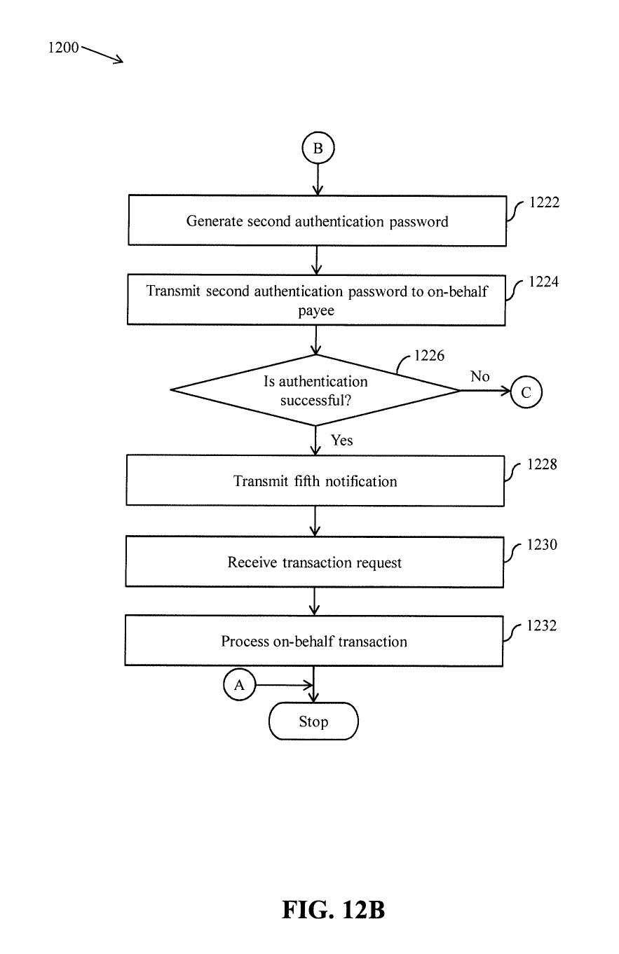

Referring now to FIGS. 12A and 12B, a flow chart 1200 that illustrates the method for authorizing an on-behalf transaction, in accordance with another embodiment of the present invention, is shown. At step 1202, the second transceiver 306 receives the first UIC of the on-behalf payee (i.e., the second user 108) of the first account from the issuer server 120. At step 1204, the mapping manager 310 maps the first UIC to the first account as described in FIGS. 5A and 5B. At step 1206, the second transceiver 306 receives the second authorization request for the on-behalf transaction performed from the first account by the second user 108. The second user 108 performs the on-behalf transaction by using the first UIC. At step 1208, the second authorization manager 312 retrieves the account profile of the first account based on the second authorization request. At step 1210, the second authorization manager 312 determines whether the first UIC included in the second authorization request is valid or invalid. If at step 1210, it is determined that the first UIC is invalid, step 1212 is performed. At step 1212, the second authorization manager 312 declines the on-behalf transaction. If at step 1210, it is determined that the first UIC is valid, step 1214 is performed.

At step 1214, the second authorization manager 312, in conjunction with the second transceiver 306, notifies the first user 102 (i.e., the account holder) by way of the fourth notification that the second user 108 has performed the on-behalf transaction from the first account. At step 1216, the second authorization manager 312 determines whether the on-behalf transaction is approved by the first user 102 (i.e., the account holder). If at step 1216, it is determined that the on-behalf transaction is not approved by the first user 102, step 1218 is performed. At step 1218, the second transceiver 306, in conjunction with the second authorization manager 312, transmits the second rejection message for declining the on-behalf transaction. If at step 1216, it is determined that the on-behalf transaction is approved by the first user 102, step 1220 is performed. At step 1220, the second transceiver 306, in conjunction with the second authorization manager 312, transmits the second approval message. At step 1222, the second authorization manager 312 generates the second authentication password. At step 1224, the second transceiver 306 transmits the second authentication password to the second user 108 (i.e., the on-behalf payee) by way of the contact information of the second user 108.

At step 1226, the second authorization manager 312 determines whether the authentication of the second user 108 is successful or unsuccessful. If at step 1226, it is determined that the authentication is unsuccessful, step 1212 is performed. If at step 1226, it is determined that the authentication is successful, step 1228 is performed. At step 1228, the second authorization manager 312, in conjunction with the second transceiver 306, transmits the fifth notification to one of the terminal device 112 or the second user-computing device 110 for indicating a successful authentication of the second user 108. At step 1230, the second transceiver 306 receives the second transaction request for processing the on-behalf transaction. At step 1232, the second transaction manager 314 processes the on-behalf transaction and transmits the second transaction request to the issuer server 120 for capturing or declining.

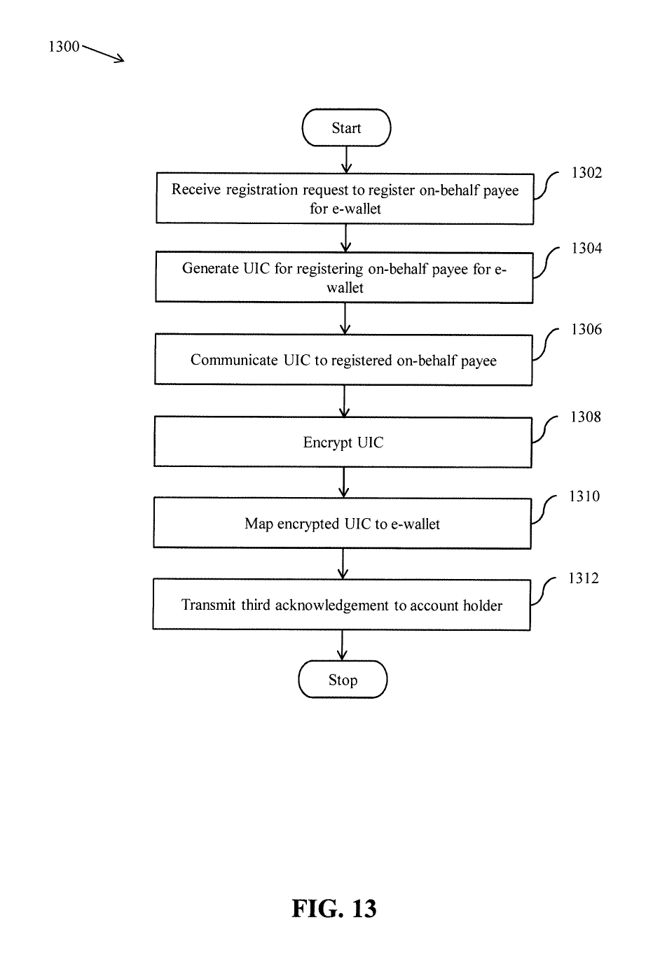

Referring now to FIG. 13, a flow chart 1300 that illustrates the method for registering an on-behalf payee for the e-wallet of the first user 102, in accordance with another embodiment of the present invention, is shown. At step 1302, the third transceiver 406 receives the second registration request to register the second user 108 as the on-behalf payee for the e-wallet of the first user 102 maintained by the merchant server 114 or the third-party server. At step 1304, the second code generator 412 generates the second UIC for registering the on-behalf payee for the e-wallet. At step 1306, the third transceiver 406 communicates the second UIC to the registered on-behalf payee (i.e., the second user 108) by way of the contact information of the registered on-behalf payee. At step 1308, the second registration manager 410 encrypts the second UIC. At step 1310, the second registration manager 410 maps the encrypted second UIC to the e-wallet as described in conjunction with FIG. 8. At step 1312, the third transceiver 406 transmits the third acknowledgement to the first user 102 (i.e., the account holder) indicating that the second user 108 is successfully registered as the on-behalf payee for the e-wallet.

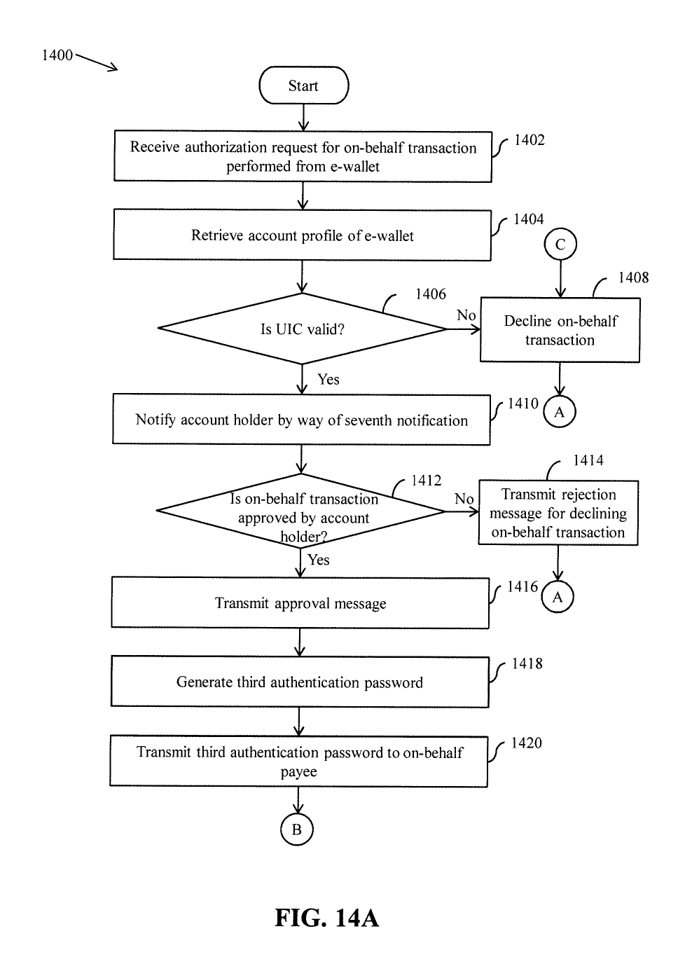

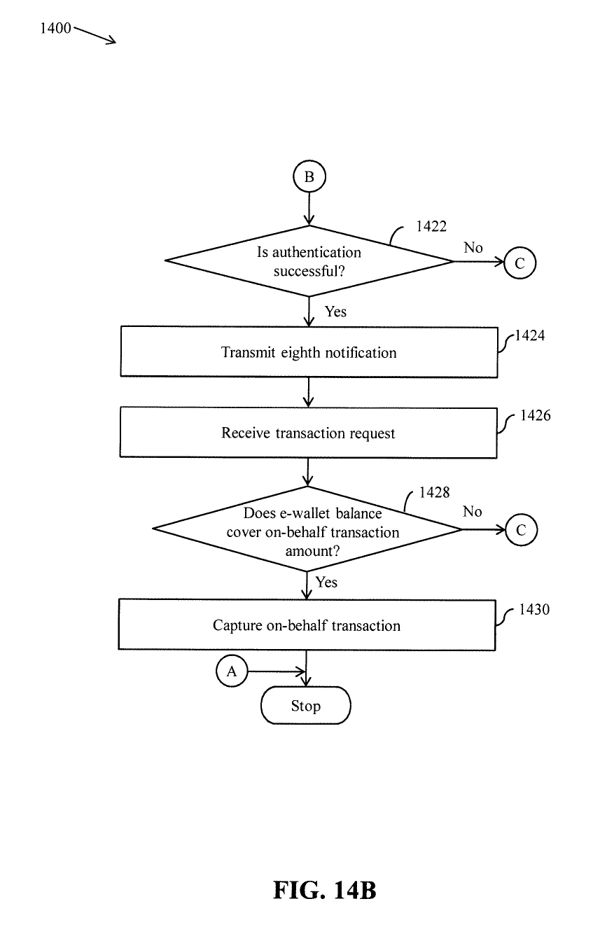

Referring now to FIGS. 14A and 14B, a flow chart 1400 that illustrates the method for authorizing an on-behalf transaction that is performed from the e-wallet, in accordance with an embodiment of the present invention, is shown. At step 1402, the third transceiver 406 receives the third authorization request for the on-behalf transaction performed from the e-wallet. The second user 108 performs the on-behalf transaction by using the second UIC. At step 1404, the third authorization manager 414 retrieves the account profile of the e-wallet based on the third authorization request. At step 1406, the third authorization manager 414 determines whether the second UIC included in the third authorization request is valid or invalid. If at step 1406, it is determined that the second UIC is invalid, step 1408 is performed. At step 1408, the third authorization manager 414 declines the on-behalf transaction. If at step 1406, it is determined that the second UIC is valid, step 1410 is performed.

At step 1410, the third authorization manager 414, in conjunction with the third transceiver 406, notifies the first user 102 (i.e., the account holder) by way of the seventh notification that the second user 108 has performed the on-behalf transaction from the e-wallet. At step 1412, the third authorization manager 414 determines whether the on-behalf transaction is approved by the first user 102 (i.e., the account holder). If at step 1412, it is determined that the on-behalf transaction is not approved by the first user 102, step 1414 is performed. At step 1414, the third transceiver 406, in conjunction with the third authorization manager 414, transmits the third rejection message for declining the on-behalf transaction. If at step 1412, it is determined that the on-behalf transaction is approved by the first user 102, step 1416 is performed. At step 1416, the third transceiver 406, in conjunction with the third authorization manager 414, transmits the third approval message. At step 1418, the third authorization manager 414 generates the third authentication password. At step 1420, the third transceiver 406 transmits the third authentication password to the second user 108 (i.e., the on-behalf payee) by way of the contact information of the second user 108.

At step 1422, the third authorization manager 414 determines whether the authentication of the second user 108 is successful. If at step 1422, it is determined that the authentication is unsuccessful, step 1408 is performed. If at step 1422, it is determined that the authentication is successful, step 1424 is performed. At step 1424, the third transceiver 406, in conjunction with the third authorization manager 414, transmits the eighth notification for indicating a successful authentication of the second user 108. At step 1426, the third transceiver 406 receives the third transaction request for processing the on-behalf transaction. At step 1428, the third transaction manager 416 determines whether the e-wallet balance covers the on-behalf transaction amount of the on-behalf transaction. If at step 1428, it is determined that the e-wallet balance does not cover the on-behalf transaction amount, step 1408 is performed. If at step 1428, it is determined that the e-wallet balance covers the on-behalf transaction amount, step 1430 is performed. At step 1430, the third transaction manager 416 captures the on-behalf transaction.

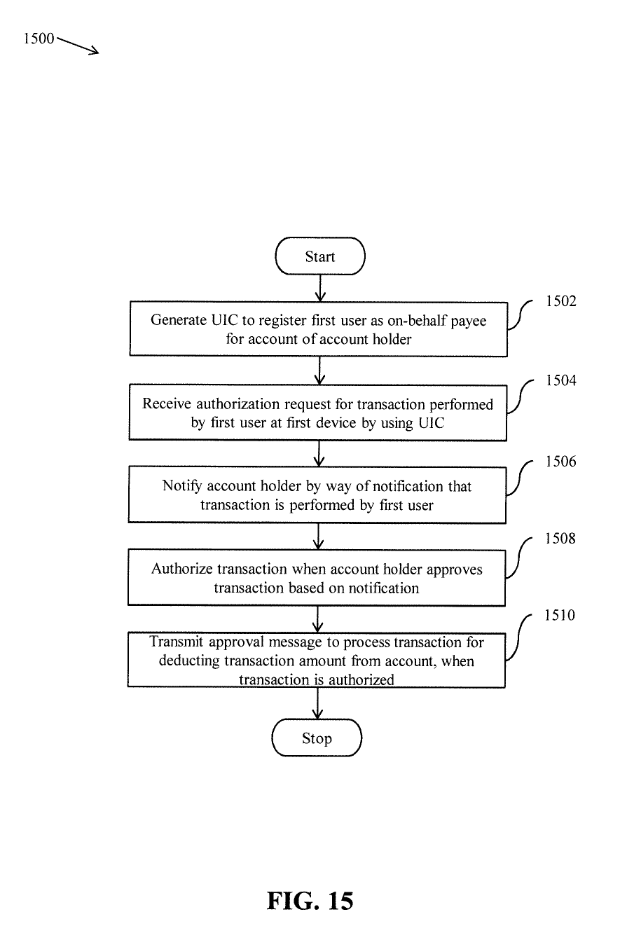

Referring now to FIG. 15, a high-level flow chart 1500 that illustrates the method for authorizing the on-behalf transactions, in accordance with an embodiment of the present invention, is shown. At step 1502, a server (such as, the merchant server 114, the payment network server 118, the issuer server 120, or the third-party server) generates a UIC (such as, the first or second UIC) to register the second user 108 as the on-behalf payee for an account (such as, the first account or the e-wallet) of an account holder (such as, the first user 102). At step 1504, the server receives an authorization request (such as, the first, second, or third authorization request) for a transaction (i.e., the on-behalf transaction) performed by the second user 108 at a first device (such as, the terminal device 112 or the second user-computing device 110) by using the UIC. At step 1506, the server notifies the account holder by way of a notification (such as, the first, fourth, or seventh notification) that the on-behalf transaction is performed by the second user 108. At step 1508, the server authorizes the on-behalf transaction, when the account holder (such as, the first user 102) approves the on-behalf transaction based on the notification. At step 1510, the server transmits an approval message (such as, the first, second, or third approval message) to process the on-behalf transaction for deducting a transaction amount from the account (such as, the first account or the e-wallet), when the on-behalf transaction is authorized. The first device (such as, the terminal device 112 or the second user-computing device 110) receives the approval message and process the on-behalf transaction.

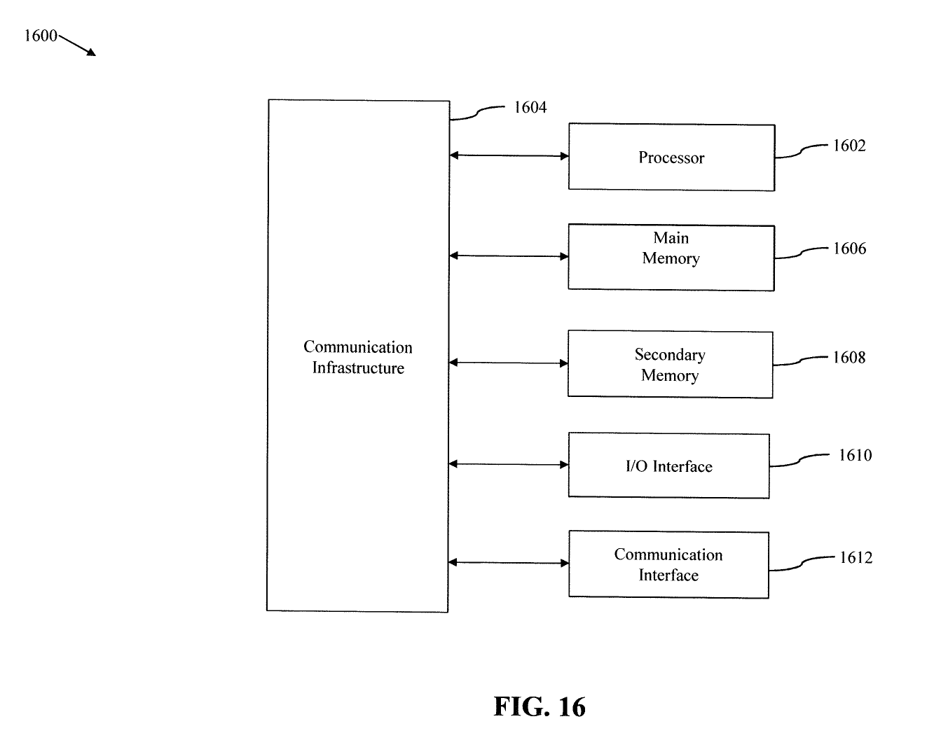

Referring now to FIG. 16, a block diagram that illustrates system architecture of a computer system 1600, in accordance with an embodiment of the present invention, is shown. An embodiment of present invention, or portions thereof, may be implemented as computer readable code on the computer system 1600. In one example, the first and second user-computing devices 104 and 110, the merchant server 114, the acquirer server 116, the payment network server 118, and the issuer server 120 of FIG. 1 may be implemented in the computer system 1600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIG. 10, FIGS. 11A and 11B, FIGS. 12A and 12B, FIG. 13, FIGS. 14A and 14B, and FIG. 15.

The computer system 1600 includes a processor 1602 that may be a special-purpose or a general-purpose processing device. The processor 1602 may be a single processor, multiple processors, or combinations thereof. The processor 1602 may have one or more processor cores. In one example, the processor 1602 is an octa-core processor. Further, the processor 1602 may be connected to a communication infrastructure 1604, such as a bus, i.e., the first, second, and third buses 208, 308, and 408, message queue, multi-core message-passing scheme, and the like. The computer system 1600 may further include a main memory 1606 and a secondary memory 1608. Examples of the main memory 1606 may include RAM, ROM, and the like. In one embodiment, the main memory 1606 is the first, second, and third memories 204, 304, and 404. The secondary memory 1608 may include a hard disk drive or a removable storage drive, such as a floppy disk drive, a magnetic tape drive, a compact disc, an optical disk drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1600 further includes an input/output (I/O) interface 1610 and a communication interface 1612. The I/O interface 1610 includes various input and output devices that are configured to communicate with the processor 1602. Examples of the input devices may include a keyboard, a mouse, a joystick, a touchscreen, a microphone, and the like. Examples, of the output devices may include a display screen, a speaker, headphones, and the like. The communications interface 1612 may be configured to allow data to be transferred between the computer system 1600 and various devices that are communicatively coupled to the computer system 1600. Examples of the communications interface 1612 may include a modem, a network interface, i.e., an Ethernet card, a communications port, and the like. Data transferred via the communications interface 1612 may correspond to signals, such as electronic, electromagnetic, optical, or other signals as will be apparent to a person skilled in the art. The signals may travel via a communications channel (not shown) which may be configured to transmit the signals to devices that are communicatively coupled to the computer system 1600. Examples of the communications channel may include, but are not limited to, cable, fiber optics, a phone line, a cellular phone link, a radio frequency link, and the like.

Computer program medium and computer usable medium may refer to memories, such as the main memory 1606 and the secondary memory 1608, which may be a semiconductor memory such as a DRAM. These computer program mediums may provide data that enables the computer system 1600 to implement the methods illustrated in FIG. 10, FIGS. 11A and 11B, FIGS. 12A and 12B, FIG. 13, FIGS. 14A and 14B, and FIG. 15. In an embodiment, the present invention is implemented using a computer implemented application, the computer implemented application may be stored in a computer program product and loaded into the computer system 1600 using the removable storage drive or the hard disc drive in the secondary memory 1608, the I/O interface 1610, or communications interface 1612.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 1602 and a memory such as the main memory 1606 and the secondary memory 1608 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Thus, the communication environment 100 enables an account holder (such as the first user 102) to register multiple on-behalf payees (such as the second user 108) for her account and e-wallet. Each on-behalf payee is authorized to perform on-behalf transactions from the account and the e-wallet by using a corresponding UIC based on consent of the account holder. Thus, the on-behalf payees do not require bank accounts, e-wallets, transaction cards, mobile applications, or smartphones linked to the bank accounts and e-wallet for performing transactions. The communication environment 100 further authenticates the on-behalf payees before processing each on-behalf transaction. Authentication adds an extra layer of security to each on-behalf transaction performed by the on-behalf payees.

Techniques consistent with the present invention provide, among other features, systems and methods for authorizing on-behalf transactions. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A transaction authorization method, comprising:
generating, by a server, a unique identification code to register a first user as an on-behalf payee for an account of an account holder;
receiving, by the server, an authorization request for a transaction performed by the first user at a first device by using the unique identification code;
notifying, by the server, the account holder by way of a notification that the transaction is performed by the first user, wherein the notification comprises details of the first user and a transaction amount of the transaction;
authorizing, by the server, the transaction, when the account holder approves the transaction based on the notification; and
transmitting, by the server to the first device, an approval message to process the transaction for deducting the transaction amount from the account, when the transaction is authorized.

2. The transaction authorization method of claim 1, further comprising receiving, by the server, a registration request from the account holder of the account to register the first user as the on-behalf payee, wherein the registration request comprises at least contact information of the first user, and wherein the unique identification code is generated based on the registration request.

3. The transaction authorization method of claim 2, further comprising communicating, by the server, the unique identification code to the first user by way of the contact information.

4. The transaction authorization method of claim 1, further comprising mapping, by the server, the unique identification code to the account.

5. The transaction authorization method of claim 1, further comprising storing, by the server, the unique identification code in an encrypted format in a memory.

6. The transaction authorization method of claim 1, further comprising registering, by the server, the first user as the on-behalf payee for performing one or more transactions from the account by using the unique identification code.

7. The transaction authorization method of claim 1, further comprising declining, by the server, the transaction, when the account holder rejects the transaction based on the notification.

8. The transaction authorization method of claim 1, further comprising authenticating, by the server, the first user, when the transaction is authorized.

9. The transaction authorization method of claim 8, further comprising declining, by the server, the transaction, when the authentication of the first user is unsuccessful.

10. A transaction authorization system, comprising:
an issuer server, comprising:
a processor that is configured to:
generate a unique identification code to register a first user as an on-behalf payee for an account of an account holder;
receive an authorization request for a transaction performed by the first user at a first device by using the unique identification code;
notify the account holder by way of a notification that the transaction is performed by the first user, wherein the notification comprises details of the first user and a transaction amount of the transaction;
authorize the transaction, when the account holder approves the transaction based on the notification; and
transmit an approval message to the first device for processing the transaction, when the transaction is authorized.

11. The transaction authorization system of claim 10, wherein the processor is further configured to receive a registration request from the account holder of the account to register the first user as the on-behalf payee, wherein the registration request comprises at least contact information of the first user, and wherein the unique identification code is generated based on the registration request.

12. The transaction authorization system of claim 11, wherein the processor is further configured to communicate the unique identification code to the first user by way of the contact information.

13. The transaction authorization system of claim 10, wherein the processor is further configured to register the first user as the on-behalf payee for performing one or more transactions from the account by using the unique identification code.

14. The transaction authorization system of claim 10, wherein the processor is further configured to decline the transaction, when the account holder rejects the transaction based on the notification.

15. The transaction authorization system of claim 10, wherein the processor is further configured to authenticate the first user, when the transaction is authorized.

16. The transaction authorization system of claim 15, wherein the processor is further configured to decline the transaction, when the authentication of the first user is unsuccessful.

17. The transaction authorization system of claim 10, wherein the processor is further configured to store the unique identification code in an encrypted format in a memory of at least one of a payment network server and the issuer server.

18. A transaction authorization method, comprising:
mapping, by a payment network server, a unique identification code that is received from an issuer server to an account of an account holder, wherein a first user is registered as an on-behalf payee by the issuer server to perform one or more transactions from the account by using the unique identification code;
receiving, by the payment network server, an authorization request for a transaction performed by the first user at a first device by using the unique identification code;
notifying, by the payment network server, the account holder by way of a notification that the transaction is performed by the first user, wherein the notification comprises details of the first user and a transaction amount of the transaction;
authorizing, by the payment network server, the transaction, when the account holder approves the transaction based on the notification; and
transmitting, by the payment network server to the first device, an approval message to process the transaction for deducting the transaction amount from the account, when the transaction is authorized.

19. The transaction authorization method of claim 18, further comprising authenticating, by the payment network server, the first user, when the transaction is authorized.

20. The transaction authorization method of claim 19, further comprising declining, by the payment network server, the transaction, when the authentication of the first user is unsuccessful or the account holder rejects the transaction based on the notification.
